(19) United States
(12) Patent Application Publication
(10) Pub. No.: US 2008/0140412 A1
(43) Pub. Date: Jun. 12, 2008

(54) INTERACTIVE TUTORING

(76) Inventors: Jonathan Travis Millman, Stamford, CT (US); Valerie Beattie, Woodland Hills, CA (US); Todd Zaorski, Wellesley, MA (US); Jeffrey M. Hill, Westford, MA (US)

Correspondence Address: FISH & RICHARDSON PC, P.O. BOX 1022, MINNEAPOLIS, MN, 55440-1022, US

(21) Appl. No.: 11/608,206

(22) Filed: Dec. 7, 2006

(51) Int. Cl. G10L 21/00

(52) U.S. Cl. 704/270

(57) ABSTRACT

Methods and related computer program products, systems, and devices for providing feedback to a user based on audio input associated with a user reading a passage from a physical text are disclosed.

### BACKGROUND

This description relates to reading.

A person's reading fluency, for example, can be developed by presenting a passage on a user interface, recognizing speech of the user reading the passage, and providing feedback on how fast the user reads and the correctness of his recognition and pronunciation. An example of software that performs such steps is shown in U.S. patent application Ser. No. 10/938,749, 10/939,295, 10/938,748, 10/938,762, 10/938,746, 10/938,758 and 11/222,493, each of which is incorporated here by reference.

### SUMMARY

In some embodiments, a system includes a memory having an electronic file with information about a sequence of words in a physical text stored thereon. The system also includes a processor configured to receive audio input from a user reading the words from the physical text and provide feedback to the user based on the received audio input and the information stored in the electronic file.

Embodiments can include one or more of the following.

The processor can be further configured to track the location of the user in the physical text based on information stored in the electronic file. The processor can be further configured to determine the initial location of the user in the physical text based on the audio input received from the user and the information in the electronic file. The electronic file can include at least one indicator associated with a particular word in the text and the processor can be further configured to play an audio file when the audio input received from the user corresponds to the word associated with the indicator. The processor can be further configured to provide feedback to the user related to the level of fluency and pronunciation accuracy for a word.

The electronic file can include an index file that includes location identifiers associated with the words in the physical text and at least one indicator can be associated with a particular word in the text. The indicators can be configured to synchronize audio with the user's reading of the physical text. The electronic file can also include word pronunciation files associated with one or more of the words in the physical text. The word pronunciation file can be an audio file with a syllable-by-syllable pronunciation of the word. The electronic tile can also include word definition files associated with one or more of the words in the physical text.

The processor can be configured to determine when a user falls to correctly recite a word in the physical text. The processor can be configured to play a particular word pronunciation file associated with the word. The processor can be further configured to receive a user request to hear a definition of a word in the physical text and play a word definition file associated with a requested word.

The physical text can be a book. The book can be an electronic book presented on an electronic book reader.

The system can also include a microphone configured to receive the audio input from a user reading the physical text and a speaker configured to provide the audio feedback to the user.

The information about a sequence of words in the physical text can include an index file that includes a list of words in the physical text and a set of one or more location identifiers associated with the words in the list of words. The location identifiers can identify the location the word occurs in the physical text. The list of words can include less than all of the words in the physical text.

In some embodiments, a method includes storing an electronic file with information about a sequence of words in a physical text, receiving audio input from a user reading the words from the physical text, and providing feedback to the user based on the received audio input and the information stored in the electronic file.

Embodiments can include one or more of the following.

The method can include tracking the location of the user in the physical text based on information stored in the electronic file. The method can include determining the initial location of the user in the physical text based on the audio input received from the user and the information in the electronic file. The electronic file further can include at least one indicator associated with a particular word in the text and the method can include playing an audio file when the audio input received from the user corresponds to the word associated with the indicator. The physical text can be a book.

In some embodiments, a computer program product, tangibly embodied in an information carrier, for executing instructions on a processor is operable to cause a machine to store an electronic file with information about a sequence of words in a physical text, receive audio input from a user reading the words from the physical text, and provide feedback to the user based on the received audio input and the information stored in the electronic file.

Embodiments can include one or more of the following.

The computer program product can be operable to cause the machine to track the location of the user in the physical text based on information stored in the electronic file. The computer program product can be operable to cause the machine to determine the initial location of the user in the physical text based on the audio input received from the user and the information in the electronic file. The electronic file can include at least one indicator associated with a particular word in the text and the computer program product can be operable to cause the machine to play an audio file when the audio input received from the user corresponds to the word associated with the indicator.

In some embodiments, a method includes receiving audio input associated with a user reading a sequence of words from a physical text and comparing at least a portion of the received audio input to stored information about the locations of words in the physical text to determine a location from which the user is reading.

Embodiments can include one or more of the following. The information about the locations of words in the physical text can be an electronic file having foreknowledge of the words from the physical text. The method can include receiving an electronic file. The physical text can be a book and the method can include receiving the electronic file from a publisher of the book. Comparing the received audio input to words in an electronic file can include matching a sequence of words in the electronic file to a sequence of words in the audio input to generate a matched sequence. The method can also include determining if the matched sequence occurs at more than one location in the physical text. The method can also include comparing additional words from the audio input to the words in the electronic file if the matched sequence occurs at more than one location in the electronic file. Matching a sequence of words can include determining if one or more words in the sequence of words is included in a set of non-indexed words and matching only the words in the audio input mat are not included in the set of non-indexed words. The method can also include determining a number of words in the audio input and matching the sequence of words only if the number of words in the audio input is greater than a predetermined threshold. The physical text can include at least some indexed words and at least some non-indexed words and the number of words comprises a number of indexed words.

Comparing the at least a portion of the received audio input to the stored information about the locations of words in the physical text to determine the location from which the user is reading can include matching a minimum sequence of words in the input file to a words in the electronic file to generate one or more matched sequences and determining if the one or more matched sequences satisfy a minimum probability threshold. Comparing the at least a portion of the received audio input to the stored information about the locations of words in the physical text to determine the location from which the user is reading can include matching a first word in the input file to a word that occurs one or more times in the electronic file, determining if a second word in the input file matches a word subsequent to the first matched word in the electronic file and determining if a third word in the input file matches a word subsequent to the first matched word and subsequent to the second word in the electronic file.

In some embodiments, a computer program product, tangibly embodied in an information carrier, for executing instructions on a processor is operable to cause a machine to receive audio input associated with a user reading a sequence of words from a physical text and compare at least a portion of the received audio input to stored information about the locations of words in the physical text to determine a location from which the user is reading.

Embodiments can include one or more of the following.

The information about the locations of words in the physical text can include an electronic file having foreknowledge of the words from the physical text. The physical text can be a book and the computer program product can be further configured to cause the machine to receive the electronic file from a publisher of the book. The computer program product can be operable to cause the machine to determine a number of words in the audio input and match the sequence of words only if the number of words in the audio input is greater than a predetermined threshold.

The computer program product can be operable to cause the machine to match a first word in the input file to a word that occurs one or more times in the electronic file, determine if a second word in the input file matches a word subsequent to the first matched word in the electronic file, and determine if a third word in the input file matches a word subsequent to the first matched word and subsequent to the second word in the electronic file.

In some embodiments, a system includes a memory having an electronic file with information about a sequence of words in a physical text stored thereon. The system also includes a processor configured to receive audio input associated with a user reading a sequence of words from a physical text, compare at least a portion of the received audio input to stored information about the locations of words in the physical text to determine a location from which the user is reading.

Embodiments can include one or more of the following.

The information about the locations of words in the physical text can include an electronic file having foreknowledge of the words from the physical text.

In some embodiments, a method for generating an electronic file corresponding to a sequence of words for use in a reading device can include receiving a sequence of words corresponding to a physical text. The method includes determining if a word in the sequence of words is included in an index file and if the word is included in the index file, adding a location identifier associated with the word to a set of location identifiers associated with the word in the index file. If the word in not included in the index file, the method includes adding the word to the list of words included in the index file and adding the location identifier associated with the word to the set of location identifiers associated with the word in the index file.

Embodiments can include one or more of the following.

The index file can include less than all of the words in the physical text. The method can include determining if the word is included in a list of non-indexed words and determining if the word is included in the index file if the word is not included in the list of non-indexed words. The location identifier can be an integer. The method can include associating location identifiers with a plurality of words in an electronic file to generate the sequence of words. The plurality of words can correspond to a plurality of words in a physical book. The plurality of words can correspond to a plurality of words in a newspaper. The plurality of words can correspond to a plurality of words in a magazine.

The physical text can be a book and the method, can include receiving the electronic file from a publisher of the book. The physical text can be a user-created text and the method can include receiving the electronic file from the user.

The method can include embedding the index file in software used to synchronize audio input received from a user to the words in the index file. The method can include identifying in the index file the locations of words received from a user. The method can include associating a definition with a word in the index file. The method can include associating a pronunciation with a word in the index file. The method can include associating a sound effect with a word in the index file. The method can include adding an indicator (e.g., a page turn indicator) associated with the layout of the words in the physical text.

In some embodiments, a computer program product, tangibly embodied in an information carrier, for executing instructions on a processor is operable to cause a machine to receive audio input associated with a user reading a sequence of words from a physical text, receive a sequence of words corresponding to a physical text, and determine if a word in the sequence of words is included in an index file. If the word is included in the index file, the computer program product is operable to cause the machine to add a location identifier associated with the word to a set of location identifiers associated with the word in the index file. If the word in not included in the index file, the computer program product is operable to cause the machine to add the word to the list of words included in the index file and add the location identifier associated with the word to the set of location identifiers associated with the word in the index file.

In some embodiments, a system includes a memory and a processor configured to receive a sequence of words corresponding to a physical text and determine if a word in the sequence of words is included in an index file stored in the memory. If the word is included in the index file, the processor is configured to add a location identifier associated with the word to a set of location identifiers associated with the word in the index file. If the word in not included in the index file, the processor is configured to add the word to the list of words included in the index file and add the location identifier associated with the word to the set of location identifiers associated with the word in the index file.

In some embodiments, a method includes using speech recognition to determine a location from which a user is reading in a physical text and synchronize at least one audio effect with the user's reading of the physical text based on the determined location and an electronic file that associates audio effects with locations in the physical text.

Embodiments can include one or more of the following.

The electronic file can include audio effect indicators, each audio effect indicator can be associated with a location in the electronic file, the audio effect indicators associate the audio effects with the locations in the physical text. Synchronizing at least one audio effect can include iteratively playing an audio file. Iteratively playing the audio file can include iteratively playing the audio file from a time the user recites a first word until a time the user recites a following word. The first word can be associated with a first audio effect indicator and the second word can be associated with a second audio effect indicator. The audio effect can be an audio effect selected from the group consisting of music and sound effects. Synchronizing at least one audio effect can include synchronizing at least one audio effect with a particular portion of the text. The electronic file can associate the audio effects with logical portions of the physical text with linguistic meaning. The logical potion can be one or more sentences in the physical text, one or more pages in the physical text, and/or one or more chapters in the physical text. The user's reading can be an ad-hoc reading with a non-predefined time scale. The audio effect can be a sound effect and synchronizing the sound effect with the user's reading can include playing an audio file associated with the sound effect after a user has recited a particular word from a particular location in the physical text.

The method can include receiving audio input from the user reading the physical text. The method can include tracking the location from which the user is reading in the physical text. The physical text can be a book.

In some embodiments, a device includes an electronic file that includes a set of words corresponding to the words in a physical text, the electronic file includes a start identifier associated with a first word and an end identifier associated with a second word, the second word being subsequent to the first word in the physical text. The device also includes a speech recognition device configured to determine when audio input received from the user corresponds to the first word. The device also includes a device configured to iteratively play an audio file indicated by the start identifier until the speech recognition device determines that audio input received from the user corresponds to the second word.

In some embodiments, a computer program product, tangibly embodied in an information carrier, for executing instructions on a processor is operable to cause a machine to receive audio input associated with a user reading a sequence of words from a physical text. The computer program produce is also configured to use speech recognition to determine a location from which a user is reading in a physical text and synchronize at least one audio effect with the user's reading of the physical text based on the determined location and an electronic file that associates audio effects with locations in the physical text.

Embodiments can include one or more of the following.

The electronic file can include audio effect indicators, each audio effect indicator can be associated with a location in the electronic file. The audio effect indicators can be configured to associate the audio effects with the locations in the physical text. The instructions to cause the machine to synchronize at least one audio effect can include instructions to cause the machine to iteratively play an audio file. The instructions to cause the machine to iteratively play the audio file can include instructions to cause the machine to iteratively play the audio file from a time the user recites a first word until a time the user recites a following word.

In some embodiments, a system includes a memory having an electronic file with information about a sequence of words in a physical text stored thereon. The system also includes a processor configured to use speech recognition to determine a location from which a user is reading in a physical text and synchronize at least one audio effect with the user's reading of the physical text based on the determined location and an electronic file that associates audio effects with locations in the physical text.

In some embodiments, a device can include an electronic file that includes a set of words corresponding to the words in a physical text, the electronic file includes a start identifier associated with a first word and an end identifier associated with a second word, the second word being subsequent to the first word in the physical text. The device also includes speech recognition device configured to determine when audio input received from the user corresponds to the first word, and a device configured to iteratively play an audio file indicated by the start identifier until the speech recognition device determines audio input received from the user corresponds to the second word.

In some embodiments, a method for assisting in learning can include receiving an audio file that includes a response from a user, generating a comparison result by comparing the response to one or more stored responses using speech recognition, determining based on the comparison result if the user has provided a correct response, and providing audio feedback to the user based on the comparison result, the audio feedback comprising feedback to assist in the user's learning.

Embodiments can include one or more of the following.

The method can include requesting a response from the user. The one or more stored responses can include at least one correct response and at least one incorrect response. The incorrect response can be associated with an identifiable type of error. Providing audio feedback to the user based on the comparison result can include playing a first audio file indicating a correct response if the comparison result indicates that a match exists between the received audio and the correct response, playing a second audio file indicating the type of error if the comparison result indicates that a match exists between the received audio and the incorrect response, and playing a third audio file if the comparison result indicates that a match does not exist between the received audio and the correct response or the incorrect response. The first audio file, second audio file, and third audio file can be different.

Requesting the response from the user can include asking the user to spell a particular word. Receiving an audio file can include receiving an audio file that includes a plurality of letters. Generating a comparison result can include determining if the plurality of letters in the audio file corresponds to the letters of the particular word. Providing audio feedback to the user can include indicating if the word was spelled correctly.

Requesting the response from the user can include asking the user to perform a particular mathematical calculation. Receiving an audio file can include receiving an audio file that includes a numeric response. Generating a comparison result can include determining if the numeric response in the audio file corresponds to the result of the calculation. Providing audio feedback to the user can include indicating if the mathematical calculation was performed correctly.

Requesting the response from the user can include reciting the lines of one or more characters in a play, but not the lines of a particular character. Receiving an audio file can include receiving an audio file that includes a line of the particular character. Generating a comparison result can include determining if the received audio file corresponds to the correct words in the line of the particular character. Providing audio feedback to the user can include providing a next word to a user if the received audio file does not correspond to the correct words in the line.

In some embodiments, a method includes using a device having foreknowledge of expected responses to provide interactive feedback to a user of the device, the interactive feedback comprising feedback to assist the user in learning a particular set of information.

Embodiments can include one or more of the following.

The particular set of information can include mathematical skills. The particular set of information can include spelling skills. The particular set of information can include comprehension skills. The particular set of information can include memorization skills.

In some embodiments, a computer program product, tangibly embodied in an information carrier, for executing instructions on a processor is operable to cause a machine to receive audio input associated with a user reading a sequence of words from a physical text. The computer program product is also configured to receive an audio file that includes a response from a user, generate a comparison result by comparing the response to one or more stored responses using speech recognition, determine based on the comparison result if the user has provided a correct response, and provide audio feedback to the user based on the comparison result. The audio feedback includes feedback to assist in the user's learning.

In some embodiments, a computer program product, tangibly embodied in an information carrier, for executing instructions on a processor is operable to cause a machine to receive audio input associated with a user reading a sequence of words from a physical text and use a device having foreknowledge of expected responses to provide interactive feedback to the user of the device. The interactive feedback includes feedback to assist the user in learning a particular set of information.

In some embodiments, a system includes a memory having one or more stored responses stored thereon. The system also includes a processor configured to receive an audio file that includes a response from a user, generate a comparison result by comparing the response to the one or more stored responses using speech recognition, determine based on the comparison result if the user has provided a correct response, and provide audio feedback to the user based on the comparison result. The audio feedback includes feedback to assist in the user's learning.

In some embodiments, a system includes a memory having foreknowledge of expected responses stored thereon. The system also includes a processor configured to use the foreknowledge of expected responses stored in the memory to provide interactive feedback to a user. The interactive feedback includes feedback to assist the user in learning a particular set of information.

Other features and advantages will be apparent from the description and from the claims.

### DESCRIPTION OF DRAWINGS

FIG. 1 is a schematic diagram of a reader and a reading helper.

FIG. 2A is a schematic diagram of a reader and a reading helper.

FIG. 2B is a schematic diagram of a reader and a reading helper.

FIG. 3A is a block diagram of a reading helper.

FIG. 3B is & block diagram of a system.

FIG. 4 is a block diagram of operation modes of a reading helper.

FIG. 5 is a flow chart of an intervention process.

FIG. 6 is a flow chart of a command process.

FIG. 7 is a block diagram of an electronic file.

FIG. 8 is a block diagram of an index.

FIG. 9 is a flow diagram of an index generation process.

FIG. 10 is a diagram of an index.

FIG. 11 is a flow diagram of a find process.

FIG. 12 is a diagram of an association of definitions, pronunciations, and text.

FIG. 13A and FIG. 13B are diagrams of an association of music, sound effects, and text.

FIG. 14 is a flow diagram of a music synchronization process.

FIG. 15 is a flow diagram of a sound effect synchronization process.

FIGS. 16A, 168, and 16C are diagrams of connections of a reading helper and another device.

FIGS. 17A, 17B, 17C, and 17D are diagrams of a user interface.

FIG. 18 is a block diagram of a reading helper that includes a bar code scanner.

FIG. 19 is a diagram of a reading helper and other entities.

FIG. 20 is a diagram of a user interface.

FIG. 21 is a diagram of a reading helper and other entities.

FIG. 22 is a diagram of a use of a narration file.

FIG. 23 is a diagram of a use by multiple users.

FIG. 24 is a flow chart of a process involving a user generated text.

FIG. 25 is a block diagram of performance data.

FIG. 26 is a flow chart of a book recommendation process.

FIG. 27 is a flow chart of a feedback process.

FIG. 28 is a flow chart of a page turn indication process.

FIG. 29 is a block diagram of a foreign language file.

FIG. 30A is a block diagram of a user and a computer system.

FIG. 30B is a block diagram of a user and a computer system.

FIG. 30C is a block diagram of a reading helper computer system.

FIG. 30D is a block diagram of a multi-user reading helper system.

FIG. 30E is a block diagram of a web-based reading helper system.

FIGS. 31A-31C provide an example of spelling practice.

FIGS. 32A-32C provide an example of spelling practice.

FIGS. 33A-33D provide an example of spelling practice.

FIG. 34 is a flow chart of a line learning process.

FIG. 35A-35H provide an example of a user learning the lines in a play.

FIGS. 36A-36F provide an example of math practice.

FIG. 37 is a block diagram of an authoring environment.

FIG. 38 is & flow chart of an electronic file generation process.

FIG. 39 is a flow chart of an electronic file generation process.

### DETAILED DESCRIPTION

### Overview

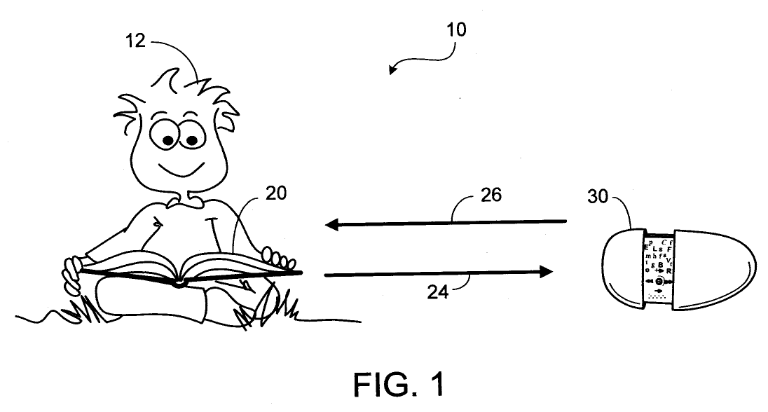

Referring to FIG. 1, a reading helper system 10 can be used to improve reading comprehension, fluency, and pronunciation. The system 10 helps a user 12 (such as a child or a non-native language speaker) to increase reading fluency based on the user's reading of a physical text 20, such as an existing published book. The reading helper 30 uses speech recognition technology to listen to the user read the text 12 in light of corresponding text captured in a stored electronic file (not shown in FIG. 1) that represents foreknowledge of the content of the book or other text 20. Among other things, the reading helper 30 helps the user 12 when the user 12 struggles with a particular word or portion of the text 20. A wide range of other information can be captured in the electronic file or in other ways and can be used to tutor the reader and serve other needs and interests of the reader.

The development of vocabulary, fluency, and comprehension interact as a person learns to read. The more a person reads, the more fluent the person becomes and the more vocabulary the person learns. As a person becomes more fluent and develops a broader vocabulary, the person reads more easily. Such interactions and development of reading skills can be encouraged by the user 12 reading out loud from a physical text 20. It is believed that reading a physical text 20 is more natural and less distracting than reading a computer-displayed text.

In general, a physical text 20 can include any form of printed material that is available to the user 12 in a paper or other tangible form such as, but not limited to conventional published books, custom made books printed on paper, programs, short stories, magazines, queue cards, games, newspapers, and many others.

Interaction between the user 12 and the reading helper 30 (as indicated by arrows 24 and 26) is facilitated by the reading helper 30 having foreknowledge of the text 20 being read by the user 12. Foreknowledge of the text 20 allows the reading helper 30 to process utterances and be used for a wide variety of purposes. In general, the user 12 reads the text 20 (as indicated by arrow 24) and the reading helper 30 provides feedback to the user 12 based on the received utterances (as indicated by arrow 26).

The reading helper 30 can be used with people of all ages. For example, the reading helper 30 can aid a user 12 who is learning how to read such as a child or an adult in early through advanced stages of reading development. The reading helper 30 can also be used by person who is learning how to read and speak a foreign language. A wide variety of other services and aids can be provided to the user 12 based on the recognized utterances of the user 12 and the related information contained in the electronic file.

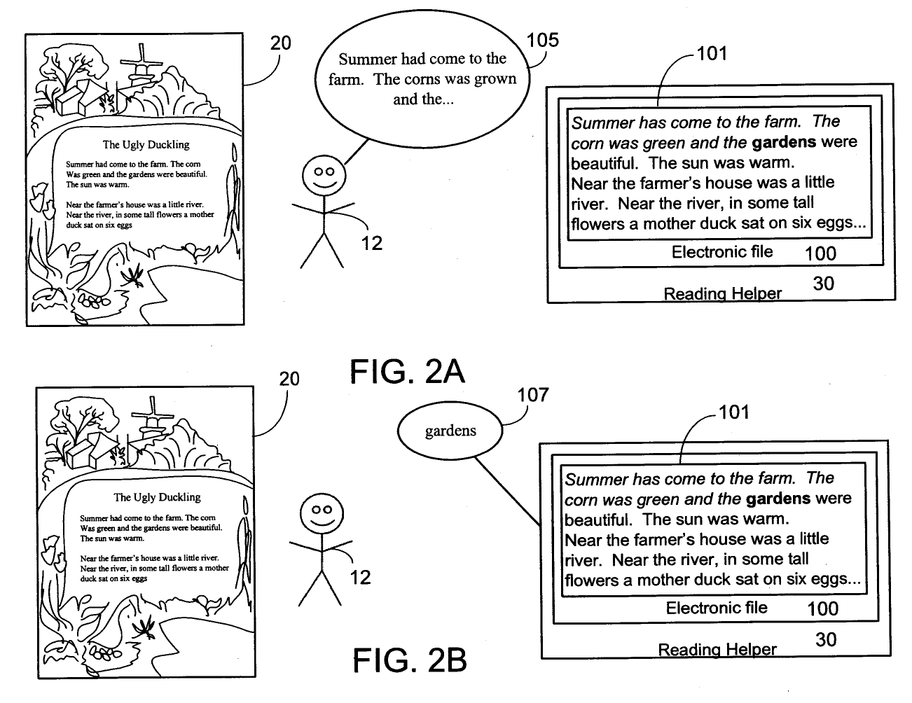

Referring to FIG. 2A, the reading helper 30 tracks the location of a user 12 while the user 12 is reading from a physical copy of a text 20. In this example, the text 20 is the book entitled “The Ugly Duckling.” The reading helper 30 uses foreknowledge of the text of “The Ugly Duckling” that is stored in an electronic file 100 to track the user's location in the text 20 while the user 12 reads out loud. Among other things, the electronic file 100 includes an electronic version of the text. Since the reading helper 30 has an electronic version of the text 20 that the user 12 is reading, the reading helper 30 knows what words to expect the user 12 to read and can track the user's location in the text 20 as the user 12 reads.

In FIG. 2A, the user 12 is reading the words shown on the page of the book 20. In this example, the user 12 has read the words “Summer had come to the farm. The corn was grown and the . . . .” Using speech recognition technology, the reading helper 30 is able to track the user's location and knows which words the user 12 had read (as indicated by the words in italics). The reading helper 30 also knows what word to expect from the user, namely the word “gardens” since it is the next word in the passage (as indicated by the bold font). As described above, the reading helper 30 can aid the user 12 while the user 12 is reading the text 20. For example, as shown in FIG. 2B, the reading helper 30 can provide the next word in the text 20 to the user 12 if the user 12 is struggling to read the next word in the text 20. In this example, the reading helper 30 prompts the user 12 by providing the word “gardens.”

### Devices and Processes

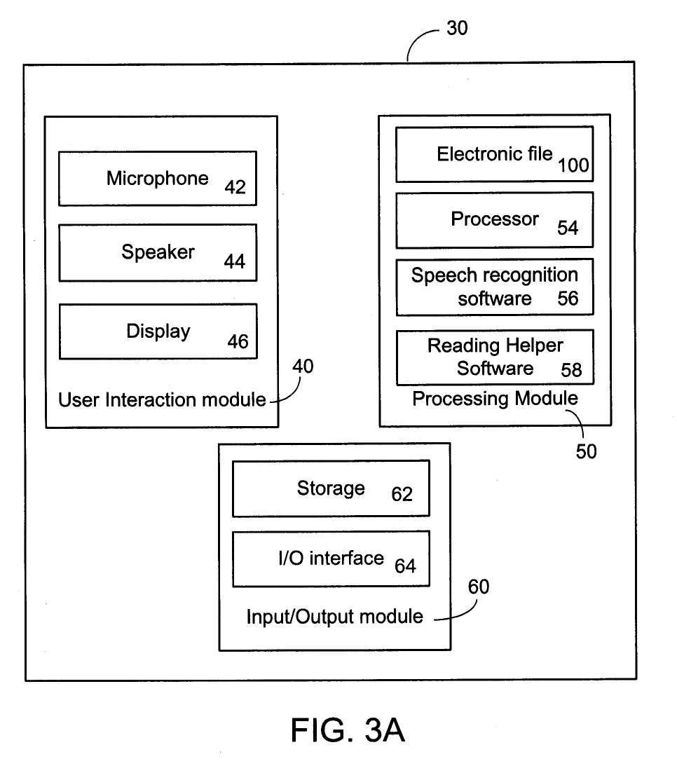

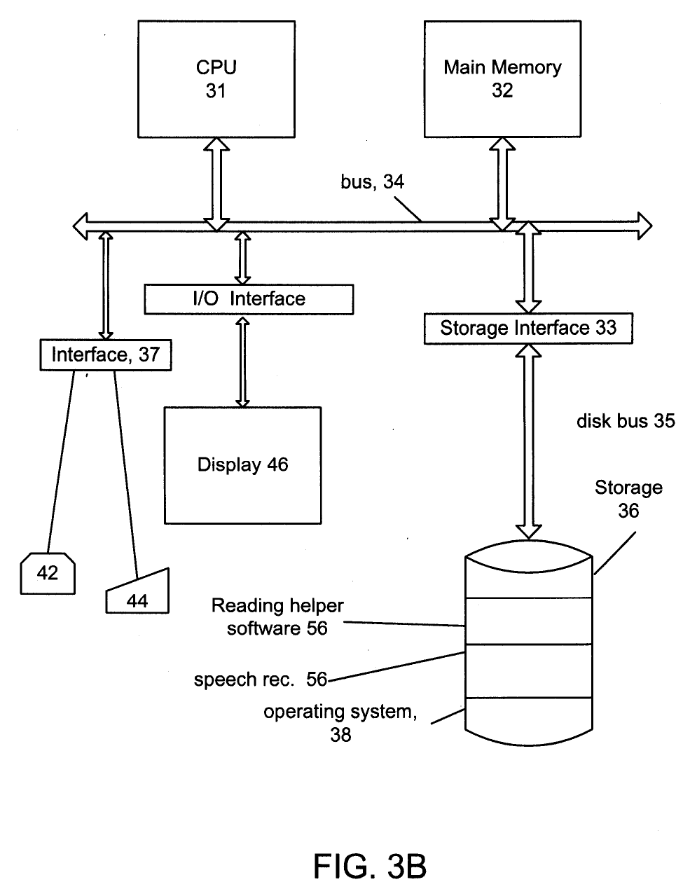

Referring to FIG. 3, the reading helper 30 may be implemented in devices and processes that provide feedback and other interactive services to a user 12 based on the user's reading. The reading helper 30 includes a user interaction module 40, a processing module 50, and an input/output module 60. Each of the modules could be implemented in a combination of hardware, software, and firmware or in other ways.

The user interaction module 40 provides an interface between the user 12 and the reading helper 30. The user interaction module 40 includes a microphone 42 for receiving, utterances from the user 12 and a speaker 44 for providing audio instructions, commands, playback of text being read, music, sound effects, and/or other feedback to the user. Either or both of the microphone 42 and the speaker 44 can be integrated within the housing of the reading helper 30 or can be external to the reading helper 30. For example, each or both of the microphone 42 and speaker 44 can be included in a headset worn by the user 12.

The reading helper 30 may include a display 46 such as a liquid crystal display (LCD). The display 46 can provide visual feedback to the user. In general, interaction with the user 12 occurs primarily through audio interactions allowing the user 12 to focus on reading the physical text 20 and listening to other readers (with or without music and/or sound effects) rather than dividing his/her attention between the physical text 20 (e.g., the printed book) and the display 46. In such embodiments, the information provided on display 46 can indicate the status of the reading helper 30, feedback to the reader concerning the person's reading, or other general information, rather than displaying the actual text being read. In some examples, when the reading helper 30 provides an intervention to the user 12, the word for which the intervention is received can be displayed on the user interlace. This allows the user 12 to both see the word and hear the word concurrently. By reducing the amount of information provided visually by the reading helper 30, the user 12 is able to focus on reading from the physical text 20 without being distracted by the reading helper 30.

Because the reader reads from and holds a book, paper, or other tangible reading material when using the reading system, the reader derives the same tactile, visual, and other pleasure that comes from reading a book, looking at images printed on the page, turning the pages, and so forth. The pleasurable aspects of buying, owning, receiving as a gift, giving, and using books and other tangible reading materials, are also experienced while at the same time the system's stored information associated with the printed material can be used for a wide variety of purposes associated with reading and learning. Publishers of books and other producers of tangible written material favor such a reading system because it provides opportunities for additional sales of their products, rather than undercutting those sales as is commonly believed to occur with electronic distribution of reading material.

The reading helper may also include input devices (not shown in FIG. 3) that can be used by the reader to control the reading helper 30, to provide information to the reading helper 30, and to provide commands to the reading helper 30. The input devices could include cursor controllers, buttons, and switches, for example.

The processing module 50 of the reading helper 30 is used to process inputs (e.g., spoken words, sounds, and/or button presses) received from the user 12 and, if necessary, provide appropriate feedback to the user 12. In general, the processing module 50 includes an electronic file 100, a processor 54, speech recognition software 56, and reading helper software 58. The electronic file 100 is associated with the physical text 20 and includes data structures that represent the passage, book, or other literary work or text being read by the user 12. The electronic file 100 may also include data structures that store other content, including music, sounds, audio tracks of the content being read, and video, for example, and metadata that represents a wide variety of information about the text or other content.

The words in a passage are linked to data structures in the electronic file 100 that store, for example, correct pronunciations for the words. The reading helper software 58 uses the correct pronunciations to evaluate whether the utterances from the user 12 are correct.

The speech recognition software 56 is used to recognize the words received from the user 12 and can be an open source recognition engine (for example, the CMU Sphinx Recognition Engine) or any engine that provides sufficient access through an application programming interface (API) or other hooks to recognizer functionality. The speech recognition software 56 in combination with the reading helper software 58 verifies whether a user's oral reading matches the words in the section of the passage the user 12 is currently reading to determine a user's level of reading ability and/or fluency.

The reading helper 30 also includes an input/output module 60 that provides an interface between the reading helper 30 and other external devices. The input/output module 60 can be used to receive electronic files 100 from other devices and to store the electronic files 100 on a storage device 62 such as a memory or a hard-drive. The input output module 60 includes an interface 64 that enables information and files stored on an external system to be transferred to the reading helper 30. Exemplary I/O interfaces include a USB port, a serial port, a disk input, a flash card input, a CD input, and/or a wireless data port. The input/output module 60 can also be used to transfer information, e.g., reading statistics or speech files, from the reading helper 30 to an external device.

Referring to FIG. 3B, a reading helper 30 can include a processor 31, main memory 32, and storage interface 33 all coupled via a system bus 34. The interface 33 interfaces system bus 34 with a disk or storage bus 35. The reading helper 30 could also include an interface 24 coupled a user interface or display device 46. Other arrangements of reading helper 30, of course, could be used. Disk 26 has stored thereon software for execution by a processor 31 using memory 32. Additionally, an interface 37 couples devices such as the microphone 42 and the speaker 44 to the bus 34.

The software includes an operating system 38 mat can be any operating system, speech recognition software 56, and the reading helper software 58 which will be discussed below. A user would interact with the reading helper 30 principally though the microphone 42 and speaker 44.

### Modes of Operation

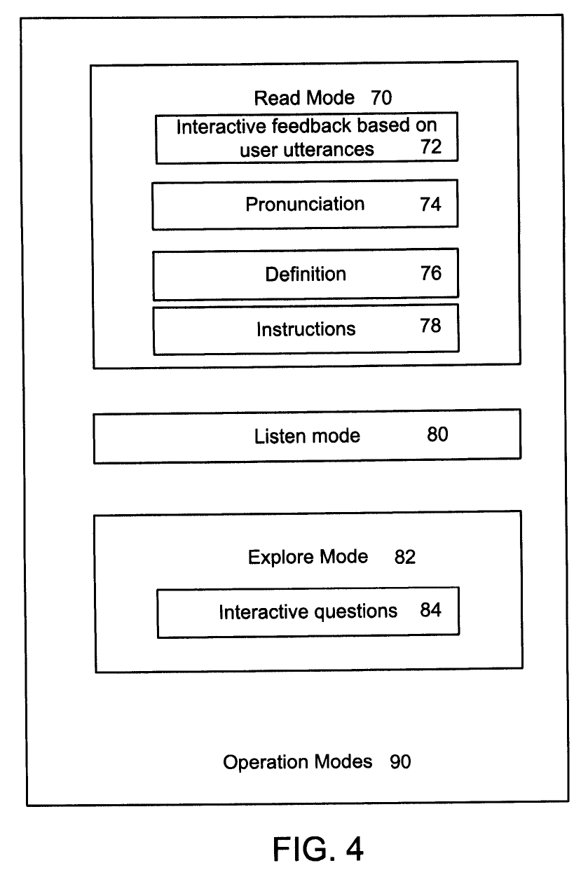

Referring to FIG. 4, the reading helper 30 includes various operation modes 90 such as a read mode 70, a listen mode 80, and an explore mode 82. The operation modes 90 can function independently and the reading helper 30 can include some or all of the operation modes 90. In addition, the reading helper 30 is not limited to these operation modes, but can include additional modes of operation. In general, in these and other operation modes, the reading helper 30 relies on the synchronization of known text to recognized text to provide various types of interactions with the user 12.

In the read mode 70, the user 12 reads a passage from, a book or other text and the reading helper 30 uses speech recognition to assess a user's reading of the passage. In read mode 70, the reading helper 30 provides interactive feedback 72 to the user 12 based on the user's reading of the passage.

The reader chooses a position in the text, e.g., a word, at which to start reading by simply starting to read from the selected location. It is not necessary for the user 12 to begin at the first word or page of the book or text 20. The reading helper 30 determines the user's location within the text (as described below). As the student reads, the reading helper 30 assesses the accuracy with which the user 12 read the words. Feedback such as prompting the user 12 of the next word or correcting a user's mistakes can be provided based, on the assessment of the user's reading. The read mode 70 can also include functionality such as pronunciations 74 and definitions 76. The pronunciations 74 are audio files of a pronunciation of a particular word. The audio files can be played to the user 12 to demonstrate to the user 12 how the word should be pronounced. The pronunciations 74 and definitions 76 can be provided to the user 12 when the user 12 struggles to read a particular word or based on a request for a pronunciation 74 or definition 76 received from the user.

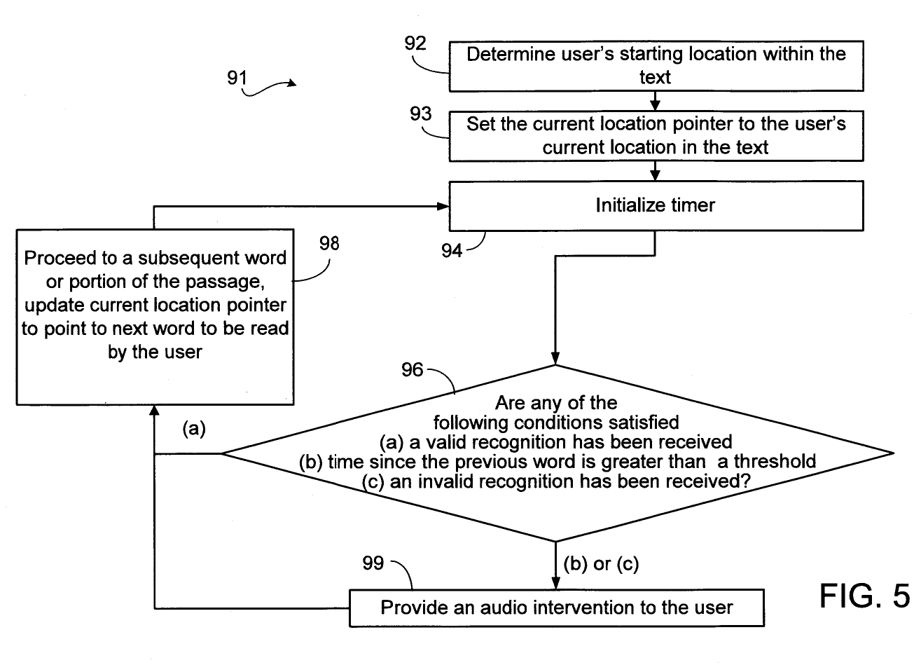

Referring to FIG. 5, an exemplary process 91 for providing feedback to the user 12 based on foreknowledge of the text 20 the user 12 is reading is shown. The reading helper 30 determines (92) the user's starting location in the text based on foreknowledge of the text stored in the electronic file 100 (as described below). The reading helper 30 sets (93) a current location pointer to the user's current location in the electronic file 100. The current location pointer is used to indicate to the reading helper 30 the next word expected from the user 12. The reading helper 30 initializes (94) a timer, e.g., a software timer or a hardware timer can be used. The timer can be initialized based on the start of a silence (no voice input) period, the start of a new audio buffer or file, the completion of a previous word, or another audio indication. Process 91 determines (96) if any of the following conditions are met: (a) a valid recognition has been received (b) a the length of time elapsed since the start of the timer is greater than is greater than a threshold or (c) an invalid recognition (e.g., an incorrect pronunciation, a skipped word, an incorrect word) has been received.

If a valid recognition is received (condition (a) is met in response to determination 96), the reading helper 30 proceeds (98) to a subsequent word in the passage and updates the current location pointer to point to the next word in the electronic file (e.g., the next word expected from the user). Subsequently, the reading helper 30 re-initializes (94) the timer.

If the time exceeds the threshold (condition (b) is met in response to determination 96) or an invalid recognition has been received (condition (c) is met in response to determination 96), the reading helper 30 provides (99) and audio intervention. For example, the reading helper can play an audio file with, a pronunciation and/or definition of the word. After providing (99) an audio intervention, the reading helper 30 proceeds (98) to a subsequent word in the passage and updates the current location, pointer to point to the next word in the electronic file (e.g., the next word expected from the user). Subsequently, the reading helper 30 re-initializes (94) the timer.

As described above, reading helper 30 uses thresholds to determine whether to provide an audio intervention to the user 12. These thresholds can be predetermined or can be adaptive based on the reading ability of the reader. For example, the reading helper 30 can assess the reader's level of reading ability and lengthen or shorten the time thresholds based on the determined reading ability.

In some embodiments, the reading helper 30 can be configured to intervene on a subset of less than all of the words in the text. For example, the words in a story can be segmented into two or more groups including target words and glue words. The glue words cm include short and/or common words that are likely to be unstressed in fluent reading of the sentence, and that are expected to be thoroughly familiar to the user 12. The glue words can include prepositions, articles, pronouns, helping verbs, conjunctions, and other standard/common words. Since the glue words are expected to be very familiar to the student, the tutor software and speech recognition engine may not require a strict match on the glue words. In some examples, the reading helper 30 may not require any recognition for the glue words. The relaxed or lenient treatment of glue words allows the reader to focus on the passage and not be interrupted by an audio intervention if a glue word is read quickly, indistinctly, or skipped entirely.

The listen mode 80 allows the reading helper 30 to read a selected book or other work to the user 12. The user 12 can follow along with the narration in his/her physical copy 30 of the book. In the listening mode 80, the narration can begin at the start of the text or the user 12 can select a location within the text for the reading to begin. For example, the user 12 can indicate a particular page or a particular sentence and the reading helper 30 will begin reading from the selected location. If the user does not select a location, the reading helper 30 starts reading from the beginning of the book or text. The reading helper 30 can also indicate to the user 12 when the user 12 should turn the page in the physical copy of the text. This can help the user 12 to stay on the same page as the narration.

The reading helper 30 can also include an explore mode 82 which allows a user 12 to explore additional areas outside reading a text or listening to a reading a text. The explore mode 82 provides interactive questions 84 to the user 12 based on a text. For example, a user 12 could read a particular book and subsequently, the reading helper 30 could ask the user 12 questions about the text.

### Command Mode

The reading helper 30 can respond to various command words spoken by the user. For example, the user 12 can switch between various modes of operation by providing the appropriate commands to the reading helper 30.

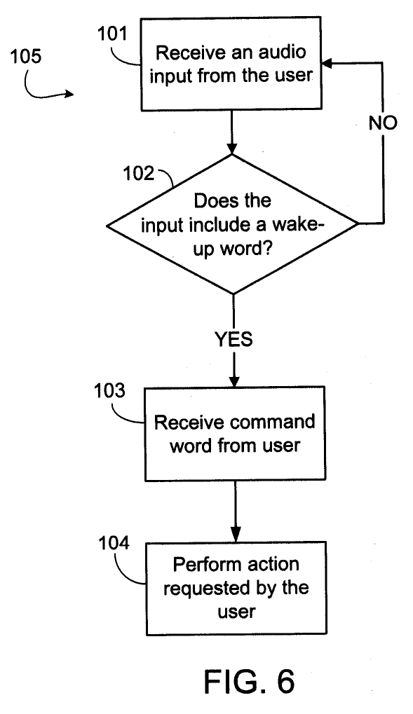

Referring to FIG. 6, a process 105 for using a “wake-up” command to alert the reading helper 30 of a command is shown. Wake-up commands can include a particular name assigned to the reading helper 30 or a particular word. In general, a wake-up command can be any word that would not commonly occur in a story or text. The reading helper 30 receives (101) audio input from the user 12 and determines (102) if the input includes the wake-up word. If the input does not include the wake-up word, the reading helper 30 returns to receiving (101) audio input Thus, the reading helper device 30 continually checks for the presence of a wake-up word or command. When the system determines that the user 12 has spoken a wake-up word, the system receives (103) a command word or phrase from the user 12. In general, when the user 12 wants to provide a command to the reading helper 30, the user 12 says the wake-up word followed by the command. After receiving the command, the reading helper 30 performs (104) the action requested by the user 12.

In some embodiments, a period of silence can additionally/alternatively be used as a wake-up command. For example, if the reading helper receives audio input corresponding to a lack of input from the user for a predetermined period of time (e.g., 5 seconds, 10 seconds, 15 seconds) followed by receipt of a command word or phrase from the user 12, the reading helper 30 interprets the period of silence as the wake-up command. After receiving the command which follows the period of silence, the reading helper 30 performs the action requested by the user 12.

Commands received by the reading helper 30 can include a “listen” command that is used when the user 12 desires to read a story and have the reading helper 30 provide feedback. Commands, received by the reading helper 30 can also include a “read” command that instructs the reading helper 30 to read to the user. After receiving a read command, the reading helper 30 can ask the user 12 what the user 12 would like to have read to them as well as who the user 12 would like to hear read the story. Commands received by the reading helper 30 can also include a “new book” command that instructs the reading helper 30 that the user 12 desires to choose a new book. Commands received by the reading helper 30 can also include a “dictionary” command that instructs the reading helper 30 that the user 12 desires to hear a dictionary definition of a word. Commands received by the reading helper 30 can also include a “find” command that instructs the reading helper 30 to find the user's location in the text. Commands received by the reading helper 30 can also include a “change user” command that instructs the reading helper 30 that someone else wants to use the reading helper device 30. Commands received by the reading helper 30 can also include “pause” and “resume” commands that instructs the reading helper 30 that the user 12 desires to stop what he/she is currently doing and later continue where they left off. Commands received by the reading helper 30 can also include a “stop” command that instructs the reading helper 30 that the user 12 desires to stop what he/she is are currently doing. In response, the reading helper 30 can ask the user 12 what he/she desires to do. Commands received by the reading helper 30 can also include a “quit” command that instructs the reading helper 30 that the user 12 wants to quit.

### Overview of the Electronic File

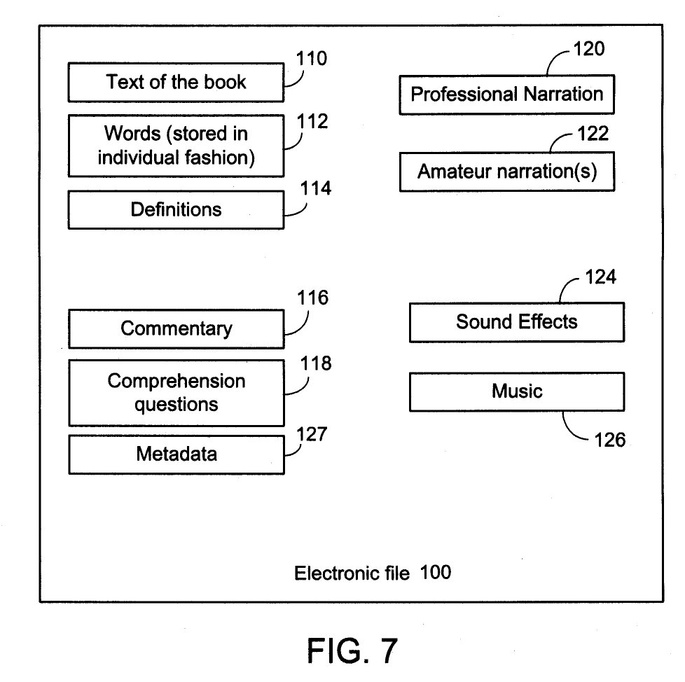

Referring to FIG. 7, the reading helper 30 associates an electronic file 100 with a particular physical text 20. The electronic file 100 includes one or more of an electronic version of the text 110, individually stored words 112, definitions 114, a professional narration 120, zero or more amateur narrations 122, commentary 116, comprehension questions 118, sound effects 124, music 126, and metadata 127. In general, the electronic file 100 is downloaded by the user 12 and stored on the reading helper 30. The electronic file 100 can include components used in various operation modes 90 of the reading helper 30 such as the read mode 70, listen mode 80, and explore mode 82 described above.

The reading helper 30 uses the electronic version of the text 110 to track the user's reading of the text. As the user 12 reads the passage, the reading helper software 58 tracks the user's location based on foreknowledge of the physical text 20 stored in the electronic file 100.

The tracking process aligns the recognition result to the expected text which is stored in the electronic file 100. The foreknowledge of the text provides a bounded context for the reading helper 30 to determine the user's location and to provide the appropriate feedback to the user 12 based on the determined location. After determining the user's initial location, in order to track the user's location, the reading helper 30 stores a current location pointer. The current location pointer indicates the current location of the user 12 in the text. As the user 12 progresses through the text, the current location pointer is updated to reflect the change in the user's position. The amount of speech needed for the reading helper 30 to determine the user's location within a text 20 varies dependent on the length and/or complexity of the text. The amount of speech needed for the reading helper 30 to determine the user's location within a text 20 can also vary dependent on the ability of the reader. For example, if the user 12 reads well, the amount of speech needed to determine his/her location may be less than if the user 12 does not read well. In general, the reading helper 30 determines the user's location based on a small amount of text (e.g. 3 words, 4 words, 5 words, a sentence).

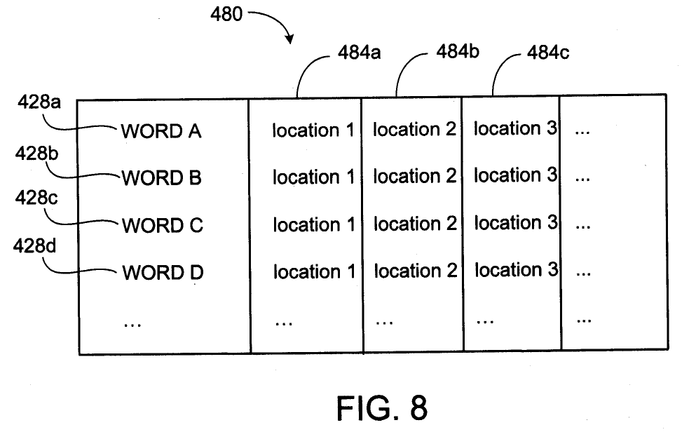

As described above, an index file provides a bounded context for the reading helper 30 to determine the user's location. In general, as shown in FIG. 8, the index file includes entries 482a, 482b, and 482c for words in the text. In a text or story, some words may be more important than other words. A text will typically include common words that are expected to be known by the student or reader; these words are referred to as glue words. The glue words can include prepositions, articles, pronouns, helping verbs, conjunctions, and other standard/common words. Exemplary glue words can include one or more of the following: a, an, am, and, are, as, at, be, by, but, can, did, do, for, from, get, go, had, has, have, he, her, him, his, I, in, into, is, it, its, it's, may, me, my, no, not, of, on, or, our, out, she, so that, their, them, the, then, they, this, to, too, the, up, us, was, we, were, what, who, with, when, whose, yes, you, and your. This list is not meant to be all inclusive; other glue words can be used by reading helper 30. Since the glue words are expected to be familiar to the student, the reader may read the word quickly, indistinctly, or skip the word entirely. In addition, glue words typically occur frequently within a story or text and therefore provide little help in determining the location of a user 12 within the text. It is believed that computation time can be reduced and/or accuracy can be improved by ignoring glue words, which occur frequently and are prone to recognition errors. Reading helper 30 does not index the glue words in a story. Thus, the words in any story are divided into two categories, indexed words which are typically the important words hi a text and non-indexed words such as glue words.

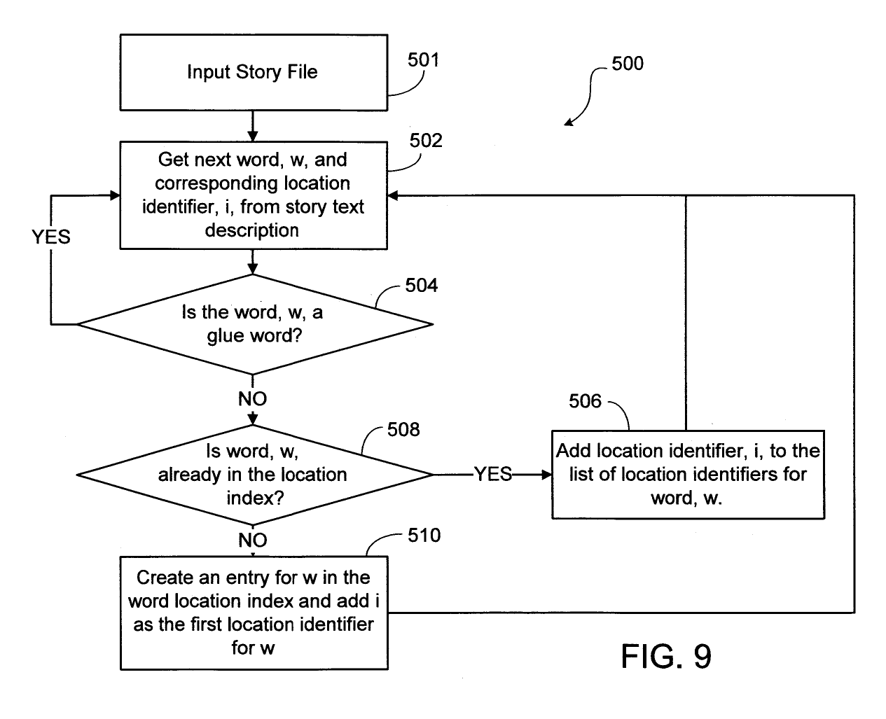

When reading helper 30 generates the index file 480 that includes entries for the words in the story and location identifiers 484a, 484b, 484c that indicate the location of the word within the text, only non-glue words are indexed and included in the index file. A process 500 for generating an index file is shown in FIG. 9. Process 500 includes receiving (501) as an input a data file (e.g., an xml file, a text file). The data file includes all of the words in the text. In the data file, each word has an identifier (e.g., an integer identifier) associated with it. Each identifier is unique within the text. After receiving the input story file, process 500 includes getting (502) the next word ‘w’ and corresponding location identifier ‘i’ from the story text description. Reading helper 30 determines (504) if the word ‘w’ is a glue word. If the word is a glue word, then the word will not be included in the index file so reading process 500 proceeds to getting (502) the next word corresponding to the next location identifier from the story text. If the word ‘w’ is not a glue word, then reading helper 30 determines (508) if the word ‘w’ is already included in the word location index file. If the word is already included in the index file (e.g., the word has been used previously in the text), then the reading helper 30 adds (506) the location identifier ‘i’ to the list of location identifiers for the word ‘w.’ If the word is not already included in the index file (e.g., the word has not been used previously in the text), the reading helper 30 creates (510) an entry for the word ‘w’ in the location index and adds the location identifier ‘i’ associated with word ‘w’ as the first location identifier in the list for the word ‘w.’

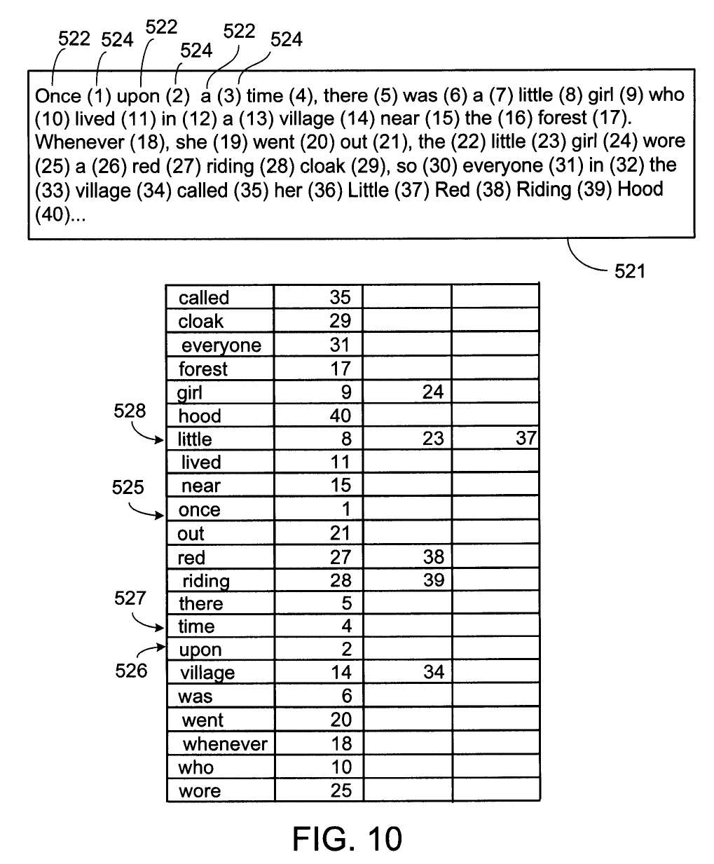

FIG. 10 shows an example of using the index file generation process 500 to generate an index file for the story “Little Red Riding Hood.” The input file 521 received by the reading helper 30 includes the words of the story 522 and associated location identifiers 524. For example, the first word in the story “once” is associated with a location identifier of 1, the second word in the story “upon” is associated with a location identifier of 2. the third word in the story “a” is associated with a location identifier of 3, the fourth word in the story “time” is associated, with a location identifier of 4, and so forth. The index file generation process begins with the first word in the story. The reading helper 30 determines that the word “once” is not a glue word and is not already in the word location file. Therefore, the word once is added to the index file and the location identifier “1” is added as the first location identifier for the word “once” (as indicated in line 525). Reading helper 30 then proceeds to the next word “upon” and determines that the word “upon” is not a glue word and is not already in the word location file. Therefore, the word upon is added to the index file and the location identifier “2” is added as the first location identifier for the word “upon” (as indicated in line 526). Reading helper 30 proceeds to the next word “a” and determines that the word “a” is a glue word and therefore, will not be added to the index file. Reading helper 30 then proceeds to the next word “time” and determines that the word “time” is not a glue word and is not already in the word location file. Therefore, the word time is added to the index file and the location identifier “4” is added as the first location identifier for the word “time” (as indicated in line 527). Some words occur multiple times within the text. For example, when the index generation process reaches the word “little” with index location identifier of 23, the word had been used previously at location identifier 8. Therefore, the index generation process determines that the word “little” is not a glue word, but the word is already in the word location index. Therefore, it is not necessary to create a new entry for the word little. Instead, the location identifier 23 is simply added to the list of location identifiers for the word little (as indicated in line 528).

Once an index file 480 has been generated, the index file 480 can be used to find the reader's location within the text based on input received from the user 12 reading the text. The foreknowledge of the text 110 included in the index file 480 provides a bounded context for the reading helper 30 to determine the user's location.

The index file 480 can be used to determine a user's location in the text (e.g., using a find process) based on input received from the user. The find process uses two levels of criteria for determining a successful match. First, the find process must have found a sufficient match to the text (M non-glue words) to be confident of the match from a recognition perspective (e.g., taking into account that there will be recognition errors). For example, the in order to have a sufficient match, the system can require a minimum number of matching non-glue words. The minimum number of matching non-glue words can be set as desired. For example, the minimum number of matching non-glue words can be set to 3,4,5, 6, and the like. The number of words can depend on various factors such as the length of the text and the variety of words, within the text. Secondly, if a match meets the first criterion the match must also be unique in the text, i.e. there isn't an equivalent (same number and sequence of non-glue words) match elsewhere in the text. The second criterion is used to avoid the problem of repeated phrases or sentences in a text.

In general, the match process iterates through each word in the recognition result, starting from the beginning. The match process “looks up” all locations for that word in the text using the word location index. For each location, the reading helper 30 matches/aligns the recognition result to the text. The alignment process is similar to that used in regular reading, i.e. non-glue words must match but glue words are not required to match. Each match is then compared against the match criteria to determine if the location corresponds to the user's location in the text.

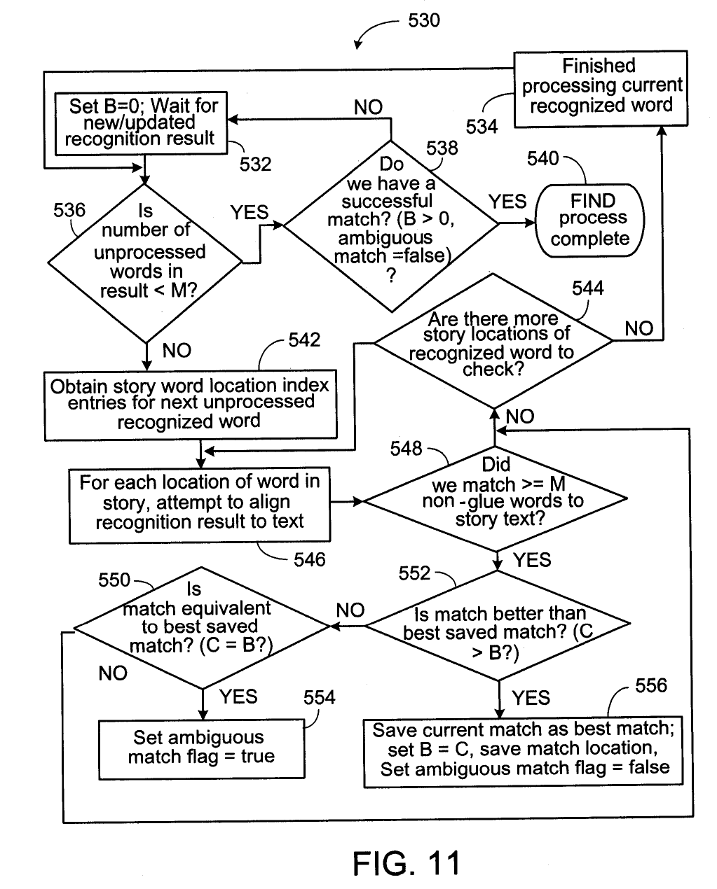

FIG. 11 shows a find process 530 for finding a user's location within a text based on input received from the user 12. The reading helper 30 sets (532) the number of matching non-glue words for the current recognition result to zero and waits for a new or updated recognition result. In general, the find process steps thorough the words in a recognition result one at a time until either a match is found within the text that identifies the location of the user 12 or until the system determines a match is not possible based on the received recognition. After receiving a recognition result from the reader, reading helper 30 determines (536) if the number of unprocessed words in the result is greater than a minimum number of matching non-glue words. This minimum number of matching non-glue words, M, can be 3 words, 4 words, 5 words, or any number of words as set by the system. If the number of unprocessed words in the result is less than the minimum number of matching non-glue words, M, the reading helper 30 determines (538) if there is a successful match. If there is a successful match, the find process is complete (540). If there is not a successful match, reading helper 30 returns to waiting (532) for anew or updated recognition result.

After receiving a recognition result from the reader, if the reading helper 30 determines (536) that the number of unprocessed words in the result is less than a minimum number of matching non-glue words, then additional words in the received recognition need to be processed in order to determine if there is a match. The reading helper 30 obtains (542) the story word location index entries for the next unprocessed recognized word. For each location of the word in the story, the reading helper 30 attempts (546) to align the recognition result to the text.

After attempting to match the recognition to the text, the reading helper 30 determines (548) if a match of greater than, or equal to the minimum number of matching non-glue words, M, has been found. If the reading helper 30 determines (548) that a match of greater than or equal to the minimum number of matching non-glue words, M, has not been found, reading helper 30 determines (544) if there are more locations in the recognized word to check. Thus, the reading helper 30 steps through the possible locations one at a time to determine if a match has been received.

On the other hand, if greater than or equal to the minimum number of matching non-glue words, M, have been matched, the reading helper 30 determines (552) if the match is better than the best saved match. If the match is better than the best saved match, the reading helper 30 saves (556) the current match as the best match, saves the match location, and sets an ambiguous match flag to false. The ambiguous flag is used to indicate situations in which the matching result is ambiguous and the reading helper 30 can not determine with a desired level or degree of confidence that a match has been found. If the match is not better than the best saved match, the reading helper 30 determines if the match is equivalent to the best saved match. If the match is equivalent to the best saved match, the reading helper 30 sets (554) the ambiguous match flag to true. If the match is not equivalent to the best saved match, the reading helper 30 determines (544) if there are more story locations of the recognized word to check and returns to attempting (546) to align the recognition result to the text. Once the reading helper 30 had stepped through the recognition result such that there are only M−1 words remaining that we have not yet considered for matches, the process can stop because it is no longer possible to meet the criterion of matching at least a minimum number, ‘M’ of non-glue words.

While a particular find algorithm is described above in relation to FIG. 11, other find algorithms could be used to determine and track the user's location in the text.

Referring back to FIG. 7, the electronic file 100 also includes word pronunciations 112 for individual words and definitions 114. The words in file 110 are indexed and linked to audio files for the words 112 and the dictionary definitions 114. Since the individual word pronunciations 112 and definitions 114 are stored separately and indexed to the electronic file 110, it is not usually necessary to store multiple copies of the word pronunciations 112 and definitions 114 for words that are used multiple times within a particular text.

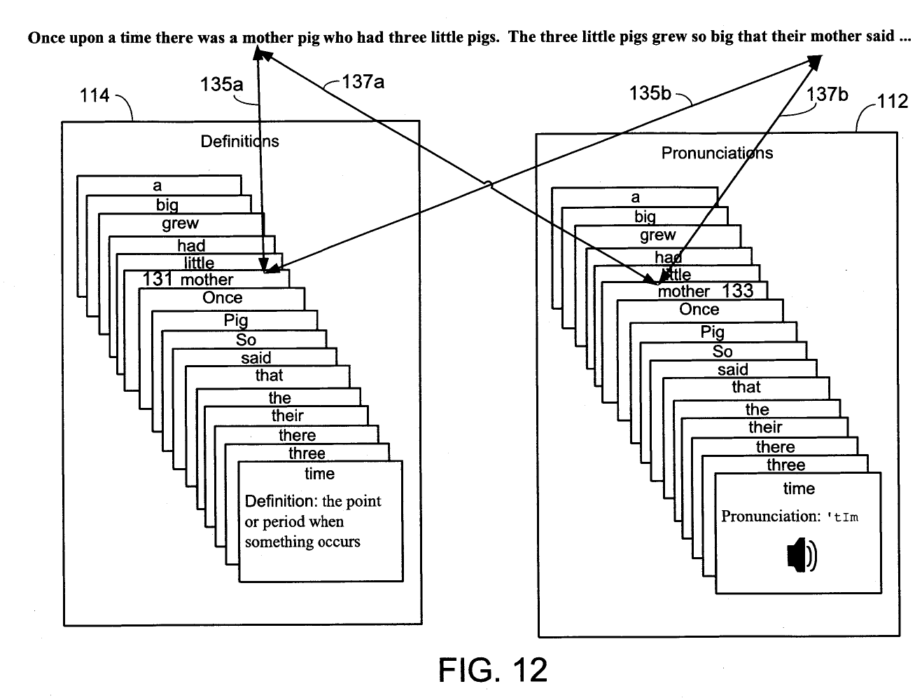

For example, as shown in FIG. 12, if the text uses a word multiple times, the multiple uses of the word in the electronic file 100 are linked or indexed to the same definition 114 and to the same word pronunciation 112. In this example, a portion of the text of the story “The Three Little Pigs” uses the word “mother” two times. Since the same word occurs multiple times, the multiple occurrences of the word are linked to the same definition 131 of the word mother (as indicated by arrows 135a and 135b). In addition, the multiple occurrences of the word are linked to the same pronunciation file 133 (as indicated by arrows 137a and 137b).

In some circumstances, the definition of a word may be context sensitive. For example, the word “star” could be used in one context to represent a luminous body in the night sky and, in another context, to indicate the principal member of a theatrical company who plays the chief role in a show. For such context sensitive words, the electronic file 100 can include multiple, context sensitive definitions of the word, and the word in the electronic file 110 is linked to the appropriate definition 114. The word pronunciation 112 for a particular word can include a normal pronunciation of the word and/or a hyper-articulated pronunciation in which each syllable of the word is articulated separately for clarity (also referred to as syllabification).

The electronic file 100 can also include one or more narrations. The narrations are electronic files of a person reading the text associated with the electronic file 100. Such narrations can include professional narrations 120 that are generated by a professional actor or actress and available to any user to download. The narrations can also include amateur narrations 122 that are created and selectively downloaded by a user 12 (as described below).

The electronic file can also include commentary 116 that includes additional comments, details, and/or questions that can be presented to the user 12. The commentary 116 can be associated with particular locations in the text such that a particular audio file is played when a user 12 reaches a predetermined location within the text. In order to test comprehension, the electronic file can also include comprehension questions 118. The comprehension questions 118 can include questions for which a predetermined answer can be stored. For example, the comprehension questions 118 could include questions that require a one word answer such as the name of a particular character in the story. Alternatively, the comprehension questions 118 could include multiple choice questions for which the user 12 selects one of a number of pre-fabricated responses or fill in the blank questions.

The electronic file 100 can also include metadata 127. The metadata 127 associated with a particular text or book can include information such as the name of the book, the version of the book, the author of the book, the publication date of the book, the reading level associated with the book and/or other information about the book. The metadata, can be used in various ways. For example, the reading helper 30 might display a portion of the metadata, e.g., the name of the book, on a user interface. Displaying such information can allow the user to confirm that the electronic file 100 currently being used by the reading helper 30 corresponds to the text he/she desires to read. Metadata 127 can also be associated with the narration files. For example, the name of the narrators and the dates on which they narrated can be associated with each narration file. This metadata 127 can be displayed to the user or recited to the user 12 when the narration file is played or recorded.

### Linking of Musk and Sound Effects to the Text

The electronic file 100 also includes music 126 and sound effects 124 which the reading helper 30 synchronizes with a user's ad-hoc reading of the book or other text 20. The music 126 and sound effects 124 can be associated with the electronic text 110 of the passage the user 12 is reading or that is being read to the user. By linking the music and sound effects to the words in the text, the music and sound effects can be played at the appropriate location in the story regardless of the speed at which the passage is read. In order to link the music and sound effects to an ad-hoc reading, the music files and sound effect files are stored separately and are associated with words in the text. Associating the music and sound effects with words in the text (as opposed to time based associations) allows the sound effects to be played at the appropriate time regardless of the speed at which the passage is read by the reader.

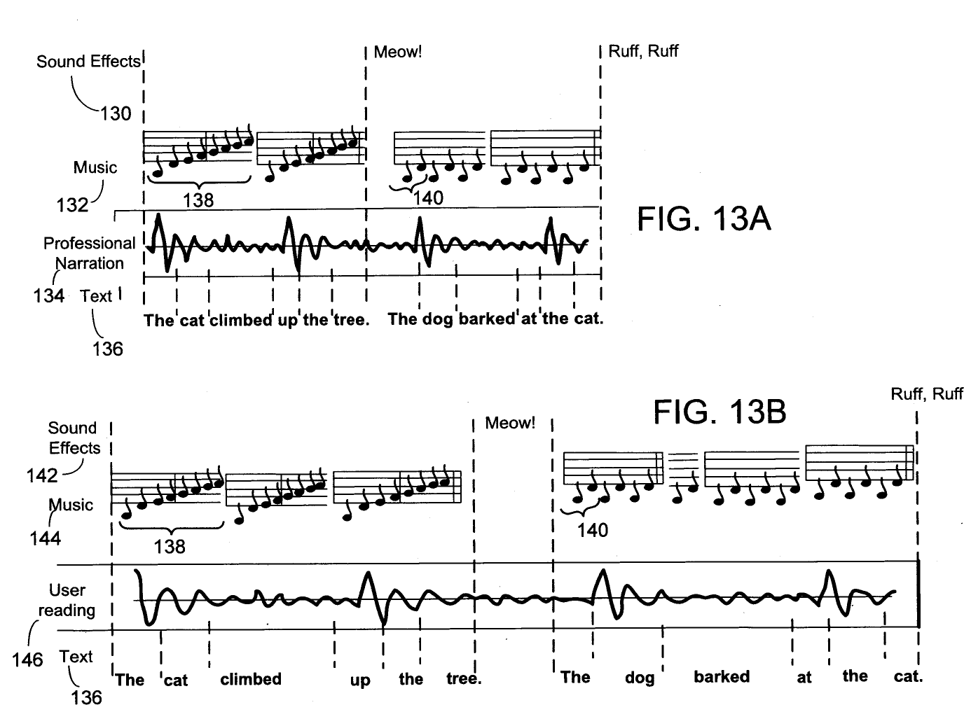

Referring to FIG. 13A, an example of how the reading helper 30 links the music 126 and sound effects 124 to a professional narration 120 is shown. The text of the passage is stored in electronic file 100. In this example, the text 136 consists of two sentences that recite “The cat climbed up the tree. The dog barked at the cat.” The words in the text are synchronized with a professional narration (shown in line 134). The music (shown in line 132) is synchronized to particular words or portions of the text 136. For example, a particular track of music can be repeated while a predetermined portion of the passage, such as a particular sentence or page, is being read. In this example, a musical track that plays a scale (indicated by arrow 138) is repeated while the first sentence is being read and a succession of two repeating notes (indicated by arrow 140) is repeated while the second sentence is being read. Due to the speed of the narration, the scale track 138 is repeated two times and the two-note succession track 140 is repeated six times when synchronized to the professional narration 134.

The sound effects (shown in line 132) are also synchronized to particular locations within the text. For example, the sound effect “meow” is played after the completion of the first sentence and the sound effect “ruff, ruff” is played at the completion of the second sentence. Associating the sound effects with words in the text (as opposed to time based) allows the sound effects to be played at the appropriate time regardless of the speed at which the passage is read by the reader.

As shown in FIG. 13B, the speed at which a user 12 reads a text can be significantly different from the speed at which the professional narrator reads the text. Despite the difference in reading speeds, the music and sound effects can be synchronized to a user's reading based on the associations of the music and sound effects with particular words or locations in the text 136. In comparison to the professional narration 134, the user's reading of the text “The cat climbed up the tree. The dog barked at the cat” is much slower. As the user 12 is reading the text, the reading helper 30 matches, in real time, the received speech (shown in line 146) with the text 136. Since the system tracks the user's location within the text 136, the appropriate music 144 and sound effects 142 are synchronized to the user's location in the text 136. In this example, based on the length of time the user 12 takes to read the two sentences, the musical tracks are looped and played a greater number of times than during the professional narration 134 shown in FIG. 13A. In particular, the musical track playing the scale is repeated three times while the user 12 reads the first sentence and the a succession of two repeating notes is repeated ten times while the second sentence is being read. Since the reading helper 30 tracks the user's location, the sound effects 142 are also played when the user 12 reaches the appropriate locations in the text. For example, the sound effect “meow” is played after the reading helper 30 recognizes the word tree and the sound effect “ruff, ruff” is played after the recognition of the word cat (i.e., at the end of the first and second sentences respectively).

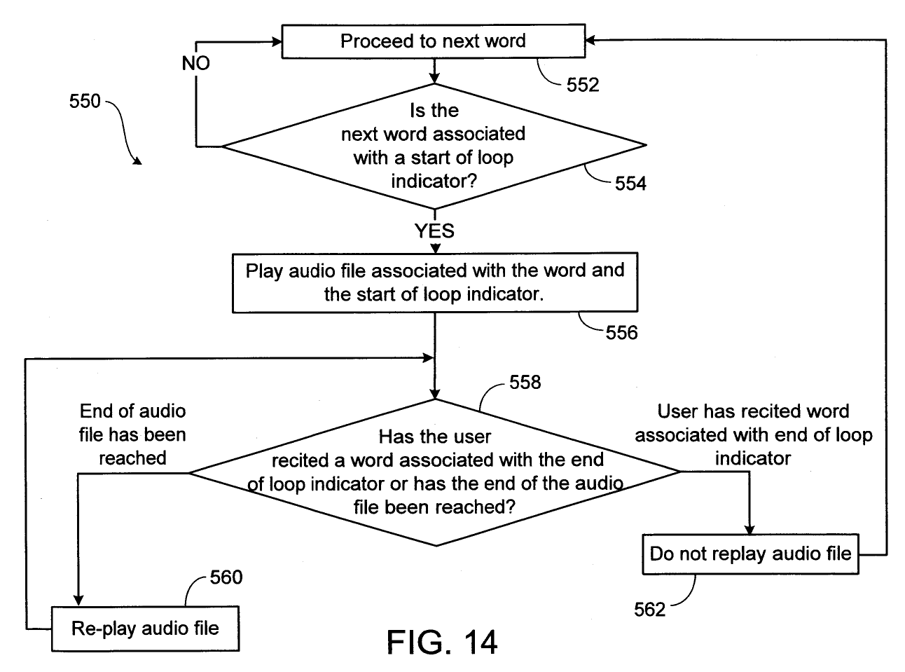

Referring to FIG. 14, a process 550 for associating musical tracks with an ad-hoc reading of a passage is shown. During a reading of a text, the reading helper 30 proceeds (552) to the next word in the audio received from a user and determines (554) if the word is associated with a start of loop indicator. In general, the time over which a musical track is repeated or looped is bounded by a start of loop indicator and end of loop indicator. The start of loop indicator is associated with a particular word or location in the text and indicates when the reading helper 30 should begin playing the audio track and the end of loop indicator is associated with a particular word or location in the text and indicates when the reading helper 30 should stop playing the audio track.

If the next word is not a start of loop indicator, the reading helper 30 proceeds (552) to the next word. If the next word is a start of loop indicator, the reading helper 30 plays (556) the audio file associated with the start of loop indicator. The reading helper determines (558) if the user 12 has recited a word associated with the end of loop indicator or if the end of the audio file has been reached. If the end of the audio file has been reached and the user 12 has not yet recited the word associated with the end of loop indicator, the reading helper 30 replays (560) the audio file. Thus, the audio file is looped and repeatedly played until the end of loop indicator has been reached. When the reading helper 30 determines (558) that the user 12 has recited the word associated with the end of loop indicator, the reading helper 30 does not replay the audio file (562) and proceeds (552) to the next word.

While FIG. 14 describes an embodiment in which the sound (e.g., a musical track) is looped such that the track is repeated until a user reaches a particular location in the text, some sound effects may be played a single time. For example, sound effects associated with a particular word may be played only a single time whereas music associated with a particular portion of the passage may be looped.

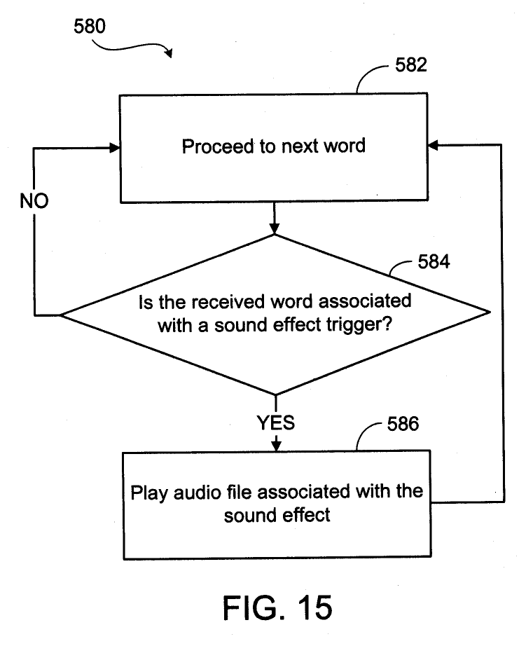

Referring, to FIG. 15, a process 580 for associating sound effects with an ad-hoc reading of a passage is shown. During a reading of a text, the reading helper proceeds (582) to the next word in a received audio file and determines (584) if the word is associated with a sound effect trigger. If the word is associated with a sound effect trigger, the reading helper 30 plays (586) the audio file associated with the sound effect. If the word is not associated with a sound effect trigger, the reading helper 30 proceeds (582) to the next word.

### Downloading the Electronic File to The Reading Helper

As described above, the reading tutor system 10 includes a physical copy of a book or other form of printed words and an electronic fife 100 with foreknowledge of the printed words in the physical copy. In some embodiments, the reading helper 30 can be configured for use with a particular book and include a pre-loaded electronic file 100 with foreknowledge of the book. This, however, would limit the user 12 of the reading helper 30 to the book or books pre-loaded onto the reading helper 30. Therefore, it can be beneficial to allow the user 12 to download the various electronic files 100 to the reading helper 30. This allows the reading helper 30 to be used with a wide variety of books and other printed materials.

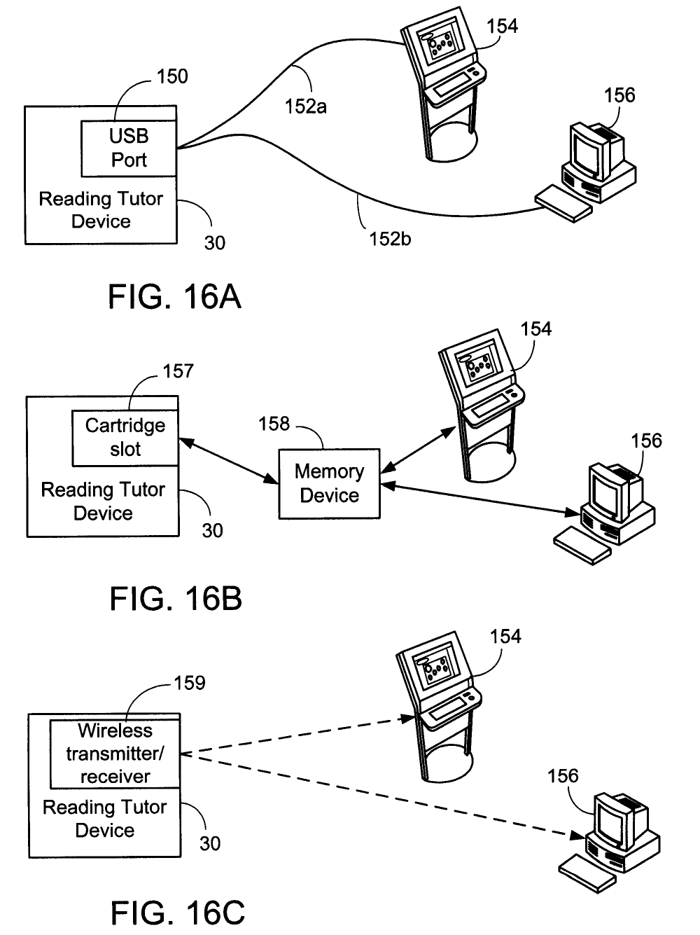

Referring to FIGS. 16A-16C, the electronic file 100 can be downloaded and stored on the reading helper 30 in various ways. For example, as shown in FIG. 16A, the reading helper 30 can include a universal serial bus (USB) port 150 for connecting the reading helper 30 to an external device that stores, or has access to, the electronic file 100. The reading helper 30 can be connected to a computer 156 or a kiosk 154 using a USB cable 152b or 152a, respectively. The kiosk 154 can include a hard drive or other memory storing electronic files 100. Alternatively, the kiosk 154 can be connected to a network (not shown), for example the internet, and the kiosk can download the requested electronic files 100 from the network. After downloading the files, the kiosk 154 transfers the files to the reading helper 30 using the USB port 150.

Kiosks can be located in places where books and other texts are obtained such as a bookstore, library, school, or newsstand. The owners of the kiosks can use the kiosks to encourage patrons to buy more books and/or the owners can charge a fee to download the electronic file. The use of a kiosk can also provide various advantages to the user 12 of the reading helper 30. For example, by having a kiosk 154 located near the place they obtain the physical book or text, the user 12 can easily obtain both the physical copy and the electronic file 100 at the same time.

In some embodiments, the user 12 can connect the reading helper 30 to his/her home computer and the computer can download the electronic file via the internet.

In some embodiments, the reading helper 30 is connected to a computer 156 that includes stored electronic files 100 and transfers the files to the reading helper 30. In other embodiments, the computer 156 accesses the electronic files via a network such as the internet (not shown).

As shown in FIG. 16B, in some embodiments, the reading helper 30 includes a cartridge slot 157. The cartridge slot 157 can accept various forms of memory devices 158 such as, for example, memory cartridges, CDs, DVDs, floppy disks, flash memory cards, USB thumbnail drives, and memory sticks. The memory device 158 can be inserted into a kiosk 154 or computer 156 that accepts the memory device 158. The kiosk 154 or computer 156 downloads an electronic file 100 to the memory device 158. The memory device 158 can be connected to the reading helper 30 using the cartridge slot 157. The electronic file can either be transferred from the memory device 158 to a memory in the reading helper 30 or can be read directly from the memory device 158 during use by the reading helper 30. In some embodiments, the user 12 buys a memory device 158 that is pre-loaded with an electronic file 100 for a particular book. For example, the memory device 158 with the pre-loaded electronic file 100 could be sold with the book.

As shown in FIG. 16C, in some embodiments, the reading helper 30 includes a wireless transmitter and receiver 159. The wireless transmitter and receiver 159 can communicate via a wireless link with a kiosk 154, computer 156, and/or base station/routes. The kiosk 154 or computer 156 downloads an electronic file 100 to the memory device via the wireless link.

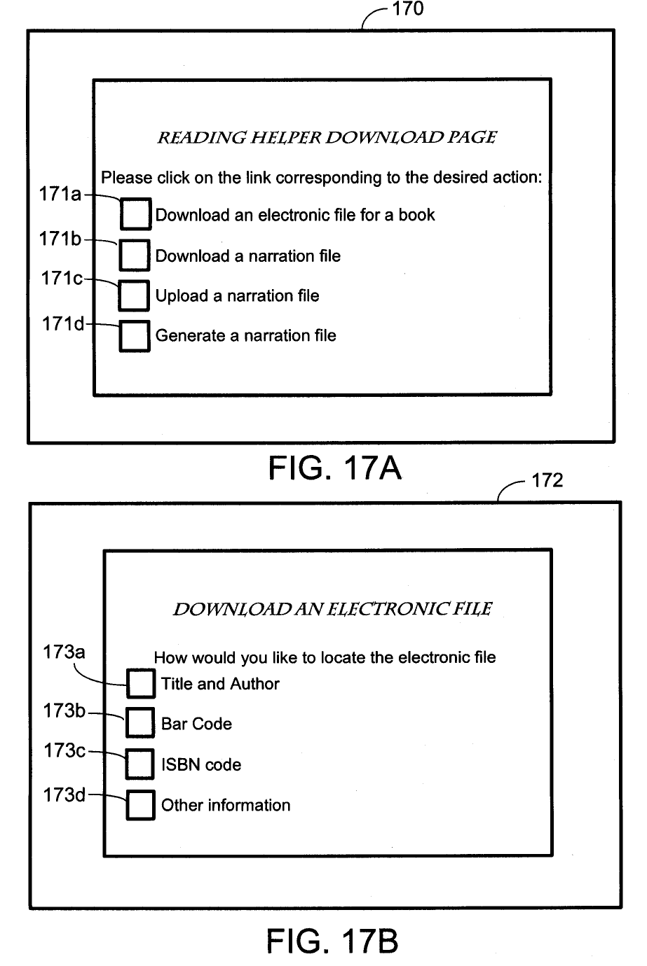

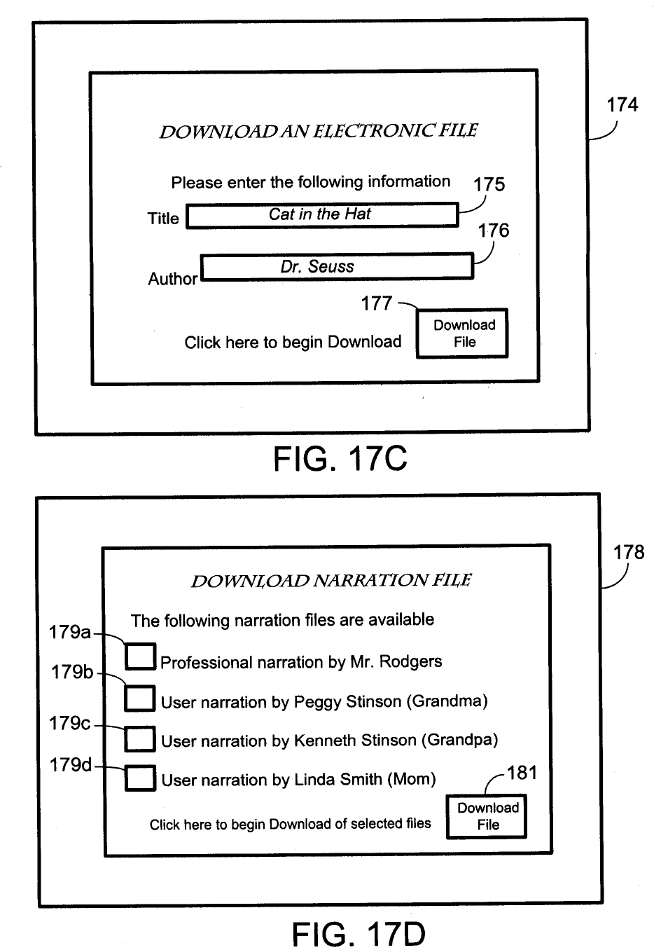

As shown above, the user 12 can download an electronic file from a computer 156 or kiosk 154. In order to download the correct file, the user 12 interacts with the computer 156 or kiosk 154 by entering various information (e.g., using a keyboard, mouse, or other input device). Referring to FIGS. 17A-17D, various exemplary user interfaces for uploading/downloading various files from the computer 156 or kiosk 154 to the reading helper 30 are shown. Input can also be received directly from the reading helper. For example, the reading helper can include buttons or a keyboard that allows the user 12 to enter data.

As shown in FIG. 17A, a user interface 170 for indicating the desired action to be taken by the computer 156 or kiosk 154 is shown. User interface 170 includes input boxes or links 171a-171d which the user 12 can select to indicate the type of file he/she desires to download or upload. For example, to download an electronic file 100 for a particular book or text, the user clicks on the box 171a, to download a narration file the user clicks on box 171b, to upload a narration file the user clicks on box 171c, and to generate a narration file the user clicks on box 171d.

FIG. 17B shows an exemplary user interface 172 for downloading an electronic file 100. User interface 172 is displayed in response to a user selecting to download an electronic file by clicking on button 171a (FIG. 17A). In order to download the electronic file, the user selects the type information about the book he/she wants to enter to locate the electronic file. For example, the user selects button 173a to locate the electronic file based on the title and author of the book, the user selects button 173b to locate the electronic file based on the bar code of the book, the user selects button 173c to locate the electronic file based on the ISBN code of the book, and the user selects button 173d to locate the electronic file based on other information.

FIG. 17C shows an exemplary user interface 174 for locating and downloading an electronic file 100 based on the title and author of a book or text. User interface 172 is displayed in response to a user selecting to enter title and author information by clicking on button 173a (FIG. 17B). In this example, the user has entered the book title “Cat in the Hat” in a title entry area 175. The user has also entered the author “Dr. Seuss” in an author entry area 176. Based on the title and author entered by the user, the system locates the electronic file for the book. The user can select to download the electronic file by clicking on the download file button 177.

FIG. 17D shows an exemplary user interface 178 for downloading a narration file. User interface 172 is displayed in response to a user selecting to download a narration file by clicking on button 17ba (FIG. 17A). The narration download user interface 178 displays narration file(s) available for the user to download. The narration files can include professional narration files and/or amateur narrations. In this example, the user can select to download a professional narration by Mr. Rodgers by selecting box 179a, a narration by Grandma by selecting box 179b, a narration by Grandpa by selecting box 179c, and/or a narration by Mom by selecting box 179d. The user selects the one or more boxes associated with the narration file(s) he/she desires to download and downloads file files by selecting the download file button 181.

In some embodiments, all narration files associated with a selected text for which an electronic file is downloaded can be automatically downloaded to the reading tutor device.

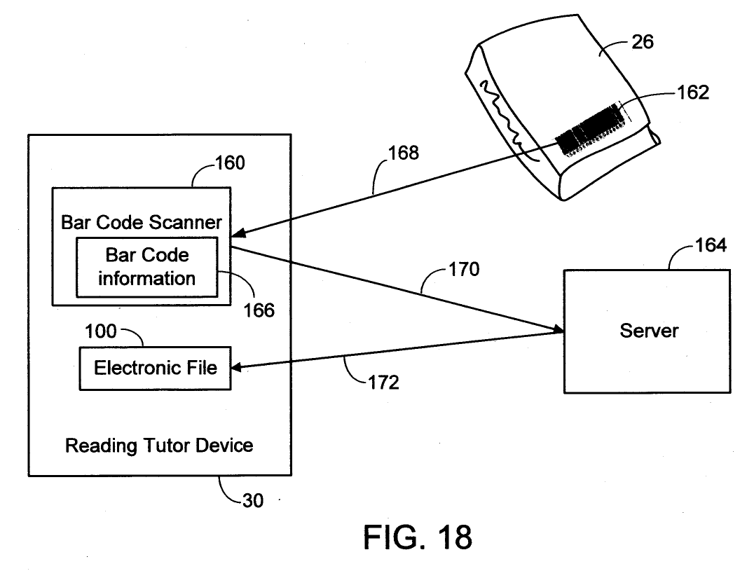

Referring to FIG. 18, in some embodiments, the reading helper 30 receives an electronic file 100 based on the bar code 162 of the book or text 20 the user 12 desires to read. In such embodiments, the reading helper 30 includes a bar code scanner 160. The user 12 scans the barcode 162 of the book 20 and the reading helper 30 stores the bar code information 166 in a memory on the reading helper 30 (indicated by arrow 168). The reading helper 30 transmits the bar code information 166 to a server 164 (indicated by arrow 170). In response, the server 164 sends the electronic file 100 associated with the bar code information 166 to the reading helper 30 (indicated by arrow 172). It is believed that using a bar code 162 to locate and download the electronic file 100 associated with a particular book 20 can provide various advantages. For example, scanning the bar code 162 can reduce the likelihood the wrong electronic file will be downloaded to the reading helper 30 because the bar code 162 provides a unique identifier for the book 20.

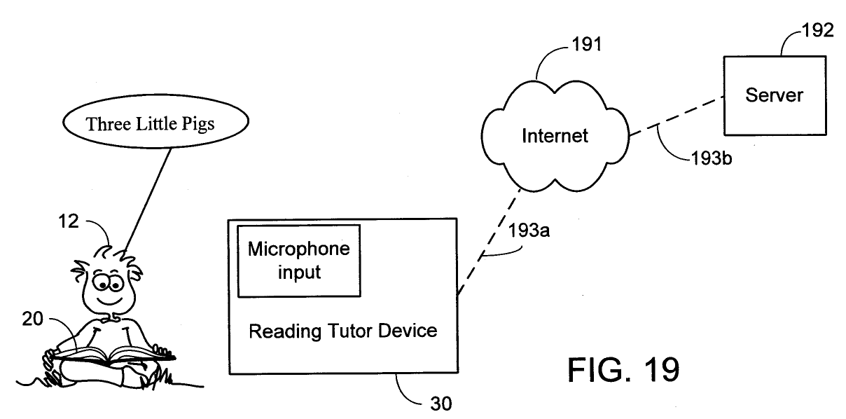

Referring to FIG. 19, in some embodiments, the reading helper 30 receives an electronic file 100 based on audio input received from the user 12. In such embodiments, the reading helper 30 can be connected directly to the internet, for example using an Ethernet, cable modem, or other connection. The user 12 says the title of the book of the book 20 and the reading helper 30 transmits the audio associated with the title to a server 192 over the internet 191 (indicated by arrows 193a and 193b). Server 192 includes an index file of all texts for which electronic files are available. The index file of the titles can be generated and parsed as discussed above in relation to determining a user's location within a text. Once the location, (e.g., the correct title) is determined, the server sends the electronic file associated with the determined title to the reading helper device 30 via the internet 191.

In some circumstances, multiple versions of a book can have the same title or multiple books can have similar titles. This can make it more difficult to determine the correct electronic file to associate with the title read by the user 12. For example, there may be multiple versions of a particular book by different publishers or multiple editions of a book by a particular publisher.

In order to determine the book for which a user 12 desires to download the electronic file 100 when multiple potential matches occur, the user 12 can provide additional information to help locate the particular book. For example, the reading helper 30 could request that the user 12 say the author's name. In some circumstances, reciting the author's name may be difficult for an inexperienced reader. For example, the name may not be easy to locate or the name may be difficult for the reader to pronounce. In some examples, rather than provide the author's name, the reading helper 30 can request that the user 12 read a particular portion of the book. For example, asking the user 12 to read the first sentence on a particular page could be used to differentiate among different books.

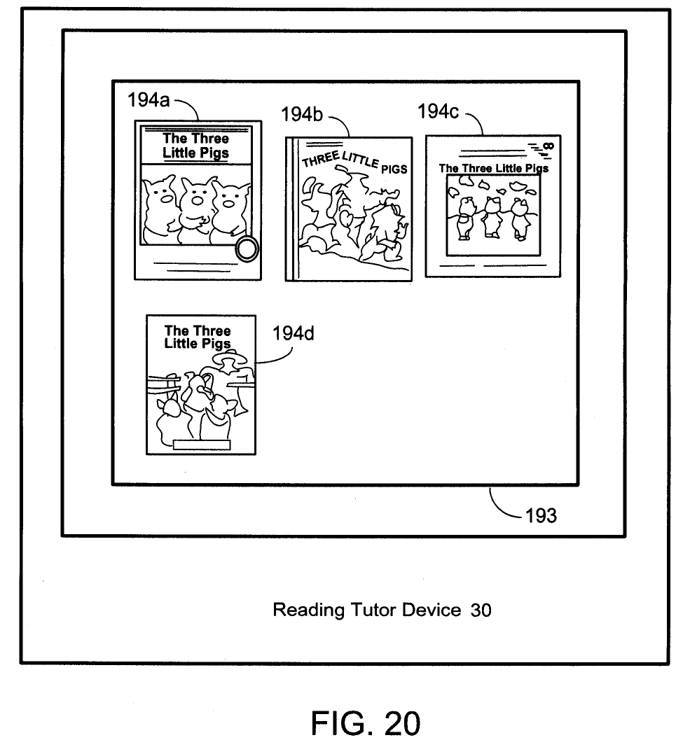

In some embodiments, as shown in FIG. 20, when multiple potential matches occur, the system can present the cover of the book to the user 12 on a user interface 193 of the reading helper 30. For example, as shown in FIG. 20, the reading helper 30 has determined that the reader desires to download the electronic file 100 associated with the book entitled “The Three Little Pigs.” However, multiple versions of this popular children's story exist. In order to provide the correct electronic file to the reader, the reading helper 30 displays the front cover 194a, 194b, 194c, and 194d of the books entitled “The Three Little Pigs” for which electronic files are available. The user 12 can select the correct book by matching one of the pictures on the display to the cover of his/her physical book and selecting the appropriate book.

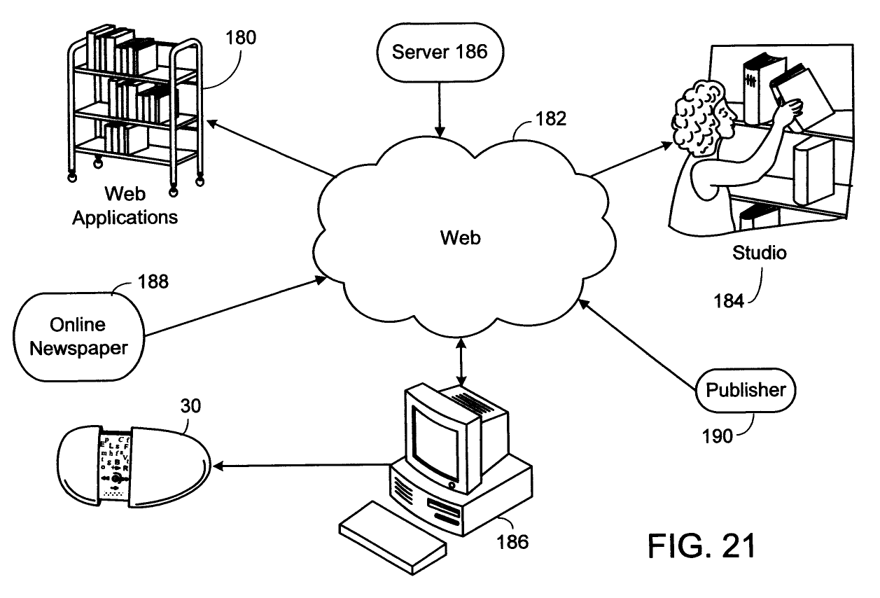

Referring to FIG. 21, in some embodiments, the reading helper 30 receives the electronic file 100 based on data about the book entered by the user. For example, the reading helper 30 can be connected to a computer 186 (e.g., a personal computer connected to the internet). The user 12 enters identification data about a particular book using the computer 186. Identification data can include the name of the book, author, publication date, serial number, unique reading helper 30 identification code, ISBN code, and/or the bar code. The computer 186 transmits the entered identification information via the web 182 to a device that stores electronic files 100 associated with the particular text the user 12 has entered. Depending on the passage or text the user 12 desires to read, the electronic file 100 can be downloaded from various sources. For example, electronic files may be stored on a server 186, in a studio 184, or in a web application 180. In some embodiments, the publisher of a particular book may store the electronic files for the book on a website or server hosted by the publisher 190. The user 12 can download the electronic file 100 from the publisher 190 after purchasing the book. By maintaining control over the distribution of the electronic files, the publisher can determine what, if any, restrictions to place on the downloading of electronic files. For example, the publisher may charge a fee for a user 12 to download the electronic file 100 or may track information about the electronic files 100 that are downloaded for marketing purposes. In some embodiments, the user 12 may desire to use the reading helper 30 to read a newspaper. If the newspaper is available online the reading helper 30 may obtain or generate the electronic file 100 for a particular article from the online version of the newspaper 188.

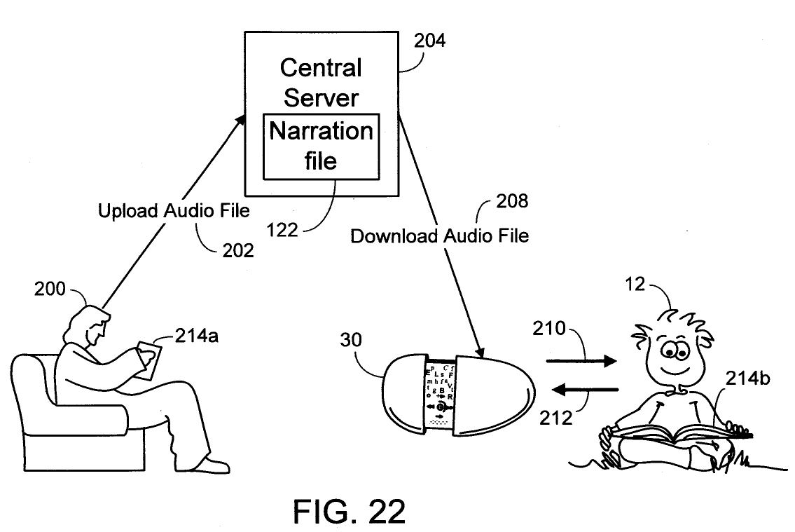

As described above in relation, to FIG. 4, in the listen mode 80 the user 12 can listen to both or either professional and amateur narrations. Amateur narration files 122 can be generated by various individuals. Referring to FIG. 22, in one example, the user 12 may desire to hear his grandmother 200 read a book to him. In order to hear the grandmother 200 read the book, the user 12 downloads a narration file 122 created by the grandmother 200. For example, the grandmother 200 can buy the same book 214a as the child's book 214b. The grandmother 200 generates a narration file 122 which is stored on a central server 204. For example, the grandmother 200 may read the book over the telephone and the central server 204 can record and store an audio recording of grandmother's reading in a narration file 122. The stored narration file 122 can subsequently be downloaded (as indicated by arrow 208) to the user's reading helper 30. Thus, a grandmother 200 or other individual in a remote location can “read” the book 214b to the user 12.

While in the example described in relation to FIG. 22, the person generating the narration file 122 is described as being a grandmother the creation of narration files 122 is not limited to grandmothers. In general, the narration file 122 can be generated by anyone with access to the server 204 or to any other mechanism for recording a narration and who has access to a copy of the book 214a to read. Thus, the user 12 can download audio files generated by others and listen to that individual read the book via the reading helper 30.

While in the example described in relation to FIG. 22, the person generating the narration file 122 read the text from a physical copy of the book, the person generating the narration file 122 could also read the text from a user interface. For example, the person generating the narration file 122 could select a particular book that the owner of the reading helper 30 possessed and then read the text of that book from a computer or other user interface to generate the narration file 122.

In some embodiments, the reading helper 30 can include a record function which records and stores audio files. The record function allows a user 12 to generate a narration file and have the narration file stored on the reading helper 30 without requiring the user 12 to upload/download the file from a remote location.

As shown in FIG. 23, the person who generates the narration file 122 does not need to be in the same location as the user 12 who downloads the narration file 122. For example, the grandmother 200 could be located in one state, e.g., Texas, while the user 12 is located in another state, e.g., California. This allows the disparately located individuals to interact with a person learning to read even though they are physically separated.

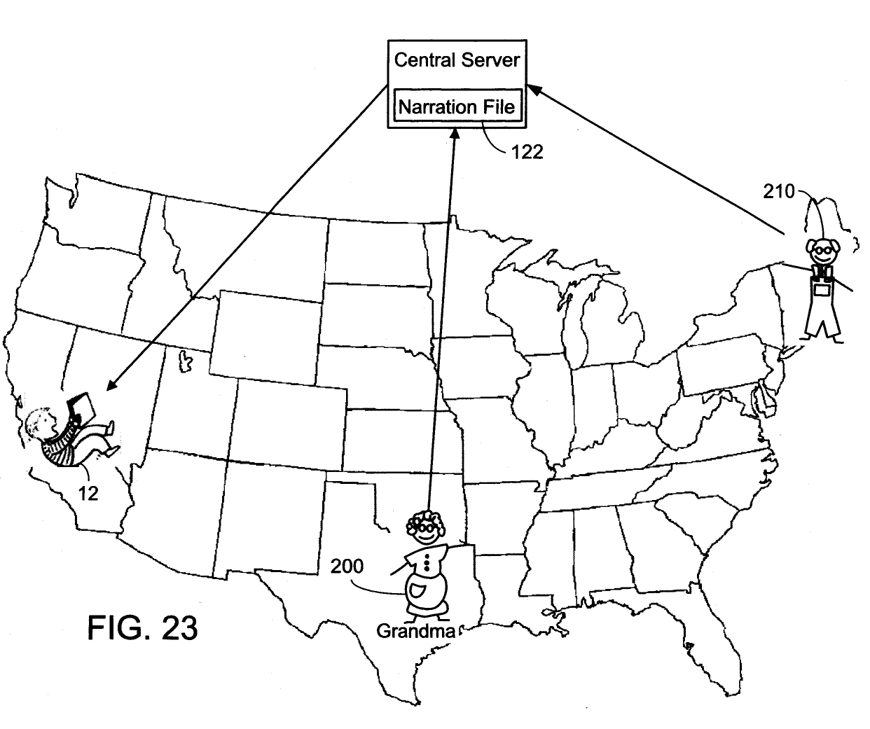

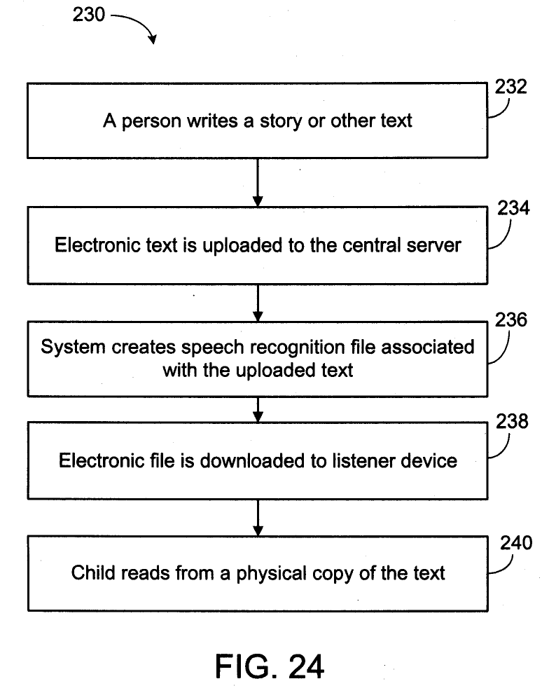

In some embodiments, a user 12 may desire to generate a user created text. For example, a teacher may create a story to emphasize a particular set of vocabulary words or reading skills. FIG. 24 shows a process 230 for using texts generated by a user with the reading helper 30. Process 230 includes an individual (e.g., a child, a teacher, a parent, a friend, a relative, etc.) writing (232) a story. The individual generates (234) an electronic version of the story and uploads the story to a central server. The server includes a program that creates (236) a speech recognition file associated with the user-generated story. For example, the program can link the words in the story with previously generated pronunciations and definitions. The user 12 who desires to read the story downloads (238) the electronic file of the user-generated story to the reading helper 30. The user 12 can also print a physical copy of the text of the story. Since the user 12 has both the physical copy of the text and the electronic file associated with the story, the user 12 can read (240) the story from the physical version and the reading helper 30 can track the user's progress and provide the necessary feedback based on the foreknowledge stored in the electronic file.

### Performance Data

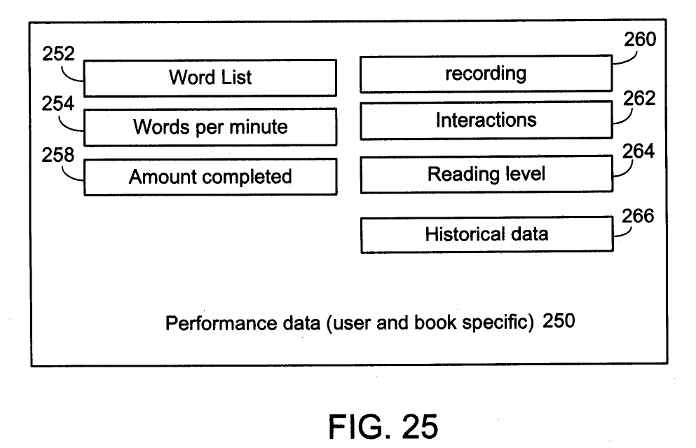

In some embodiments, the reading helper 30 can track the performance of a user 12. For example, as shown in FIG. 25, the reading helper 30 can store performance data 250 associated with the user 12 reading a particular story or text. The performance data 250 is both book and user specific and includes information such as a word list 252 of words the user 12 struggled to read or did not correctly pronounce, the number of words per minute 254, the amount of the story or passage that was read 258, a recording 260 of the user 12 reading the story, any interactions 262 generated by the reading helper 30 or requested by the user, a reading level indication 264, and historical data 266. The historical data 266 can include historical information that compares the performance data for multiple readings of the same or different texts by the user 12. Historical data 266 can be used to determine if the user's reading of the passage is improving. The historical data can include historical information about errors of the user, results of comprehension questions presented to the user, words spoken correctly per minute, and/or timing information.

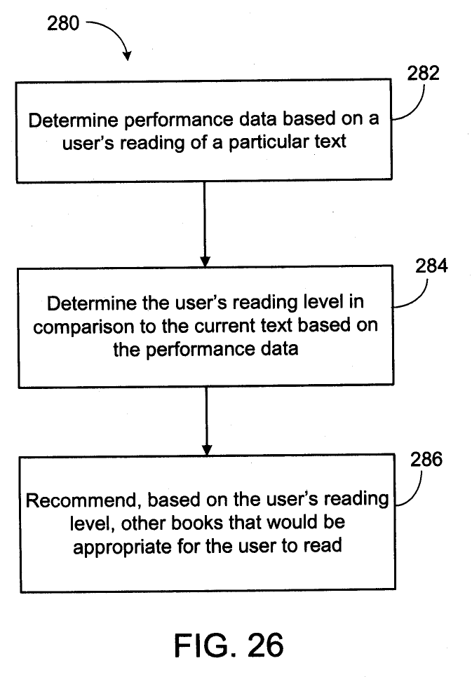

Referring to FIG. 26, in some embodiments, the reading helper 30 uses performance data 250 to generate recommendations, of other books appropriate for the user's current reading level. A process 280 for selecting appropriate books or texts includes determining (282) performance data 250 for a particular user 12 based on the user's reading a book or text. For example, a diagnostic test could be used to assess the user's current reading level. In other examples, the user 12 could read anon-diagnostic text (e.g., a book) and the reading level could be determined based on information about the text and the user's ability to accurately read the text. Based on the performance data, process 280 determines (284) the user's reading level. Process 280 uses the reading level to recommend (286) other books or texts that would be appropriate for the user 12 to read. For example, if the user 12 reads a book with few mistakes and at a high rate of words per minute, process 280 could recommend a book with a higher difficulty level. On the other hand, if the user 12 struggled to read the book, process 280 could recommend a book that is less difficult.

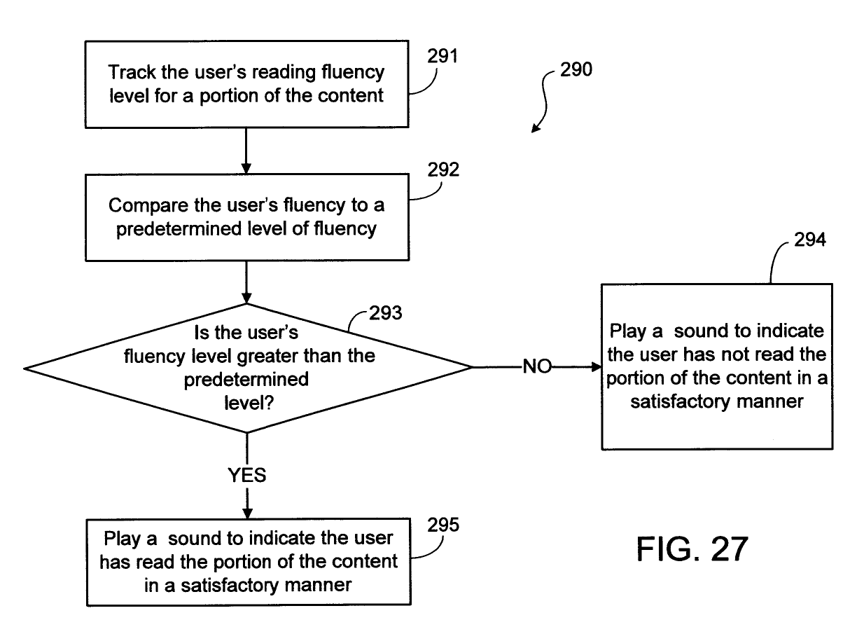

Referring to FIG. 27, the reading helper 30 can also provide feedback to the user 12 about how he/she is performing based on the determined fluency measures. In order to provide such feedback, the reading helper 30 tracks (291) the user's reading fluency level for a portion of a book or other text. The portion of the book or text can be a page, a particular number of words, a book, a chapter, or other logical points at which a person would provide feedback to the user 12 regarding his/her progress. The reading helper 30 compares (292) the user's fluency level for the portion of a book or other text to a predetermined or expected fluency level and determines (293) how the user's fluency level compares to the predetermined or expected, fluency level. If the user's reading fluency level is greater than the predetermined or expected fluency level the reading helper 30 plays (295) a sound or audio message that indicates that the user 12 has read the portion in a satisfactory manner. For example, the reading helper 30 could play an audio message such as “good job!” or “you are doing very well!” On the other hand, if the user 12 fails to meet the predetermined or expected fluency level the reading helper 30 plays (294) a message indicating that the user 12 is not performing in a satisfactory manner. For example, the reading helper 30 could instruct the user 12 to re-read the page or to try harder. By providing feedback to the user 12 while the user 12 is reading the text, the user 12 can strive to improve their reading skills in order to receive positive comments or feedback from the reading helper 30. Receiving positive feedback can also increase the reader's confidence level thereby helping the user 12 to improve his/her reading skills.

### Page Turn Indicia

In some embodiments, the electronic file 100 can include foreknowledge of the layout of the text in the physical copy of the book. For example, the pagination can be indicated in the electronic file 100 and used to generate an audio indicia indicating when the user 12 should turn the page.

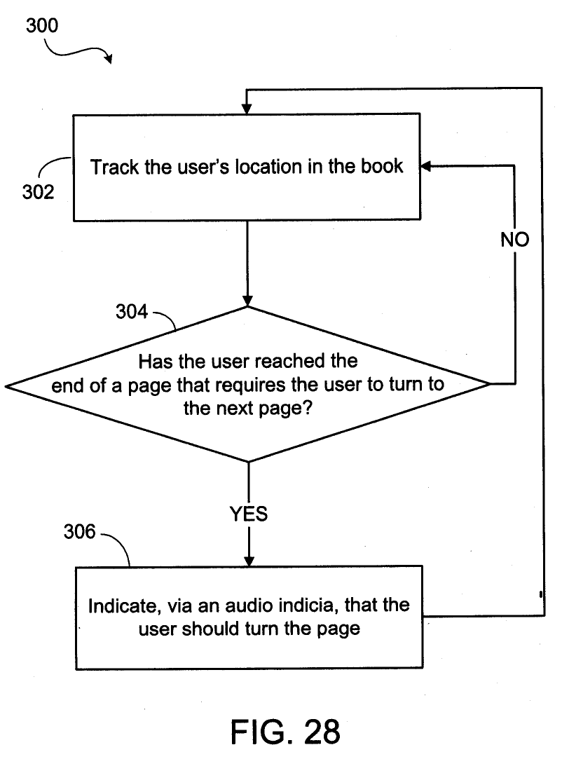

Referring to FIG. 28, a process 300 for indicating when the user 12 should turn the page in a physical book is shown. Process 302 includes tracking (302) the user's location in a book. Based on the user's location and the foreknowledge of the pagination of the book, process 300 determines (304) if the user 12 has reached the end of a page that requires the user 12 to turn to the next page. If the user 12 has not reached the end of the page, process 300 continues to track (302) the user's location. If the user 12 has reached the end of the page, process 300 indicates (306) that the user 12 should turn the page by playing an audio indicia. The audio indicia can include playing an audio recording of a person telling the user 12 to turn the page or a particular sound that indicates to the user 12 to turn the page. For example, the audio indicia could be an audio recording of bells ringing and each time the user 12 should turn the page the reading helper 30 plays the audio of the bells ringing to indicate to the user 12 to turn the page.

### Foreign Language Applications

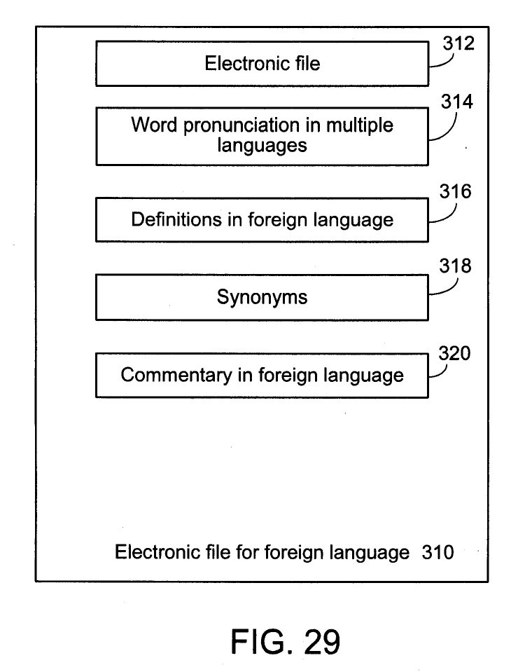

In some embodiments, the reading helper 30 can be configured to help a user 12 learn a foreign language or to learn English as a second language. For foreign language applications, additional language specific information may be stored in the electronic file 100 associated with the text. As shown in. FIG. 29, an electronic file 310 for learning a foreign language could include the electronic file of the text 312, word pronunciations in multiple languages 314, definitions in the native language of the user 316, synonyms 318 in the foreign language or the language of the text, and/or additional commentary 320 in the native language of the user. For example, if the user's first language is Spanish and the user is attempting to learn English, the pronunciations 314, definitions 316, synonyms 318, and commentary 320 can be presented in Spanish to help the user to learn the English words in the text. By presenting guidance in the language best understood by the user 12, the user 12 can be encouraged to read the text and can more easily learn new vocabulary in the foreign language.

For example, if the user is attempting to read the sentence “The shark had sharp teeth,” and the reader is not familiar with the word shark, the reader can request to hear the word in their native language. For example, if the user speaks Spanish the user reading helper 30 could play an audio file with the word Spanish translation of the word (e.g., tiburón). If the user desired to receive additional information such as a definition, this information could also be presented to the user 12 in their native language.

### Use of Phone System Instead of Stand Alone Device

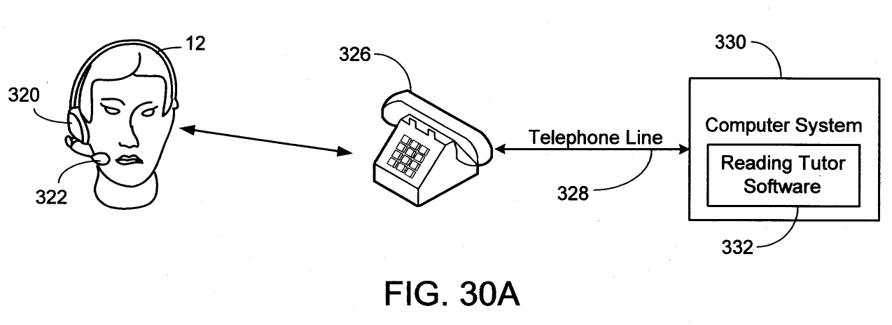

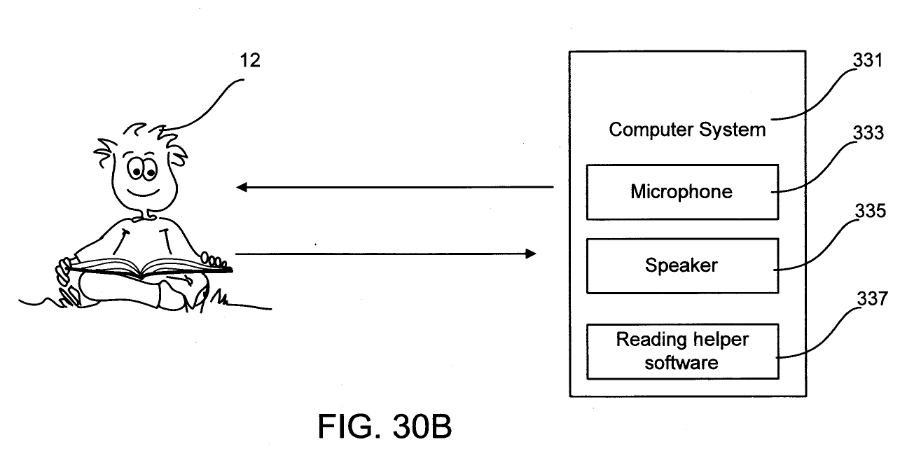

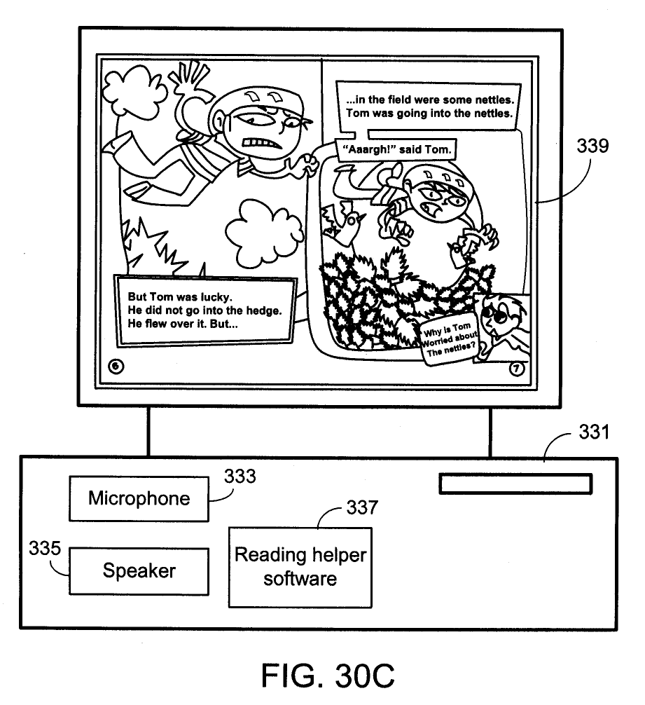

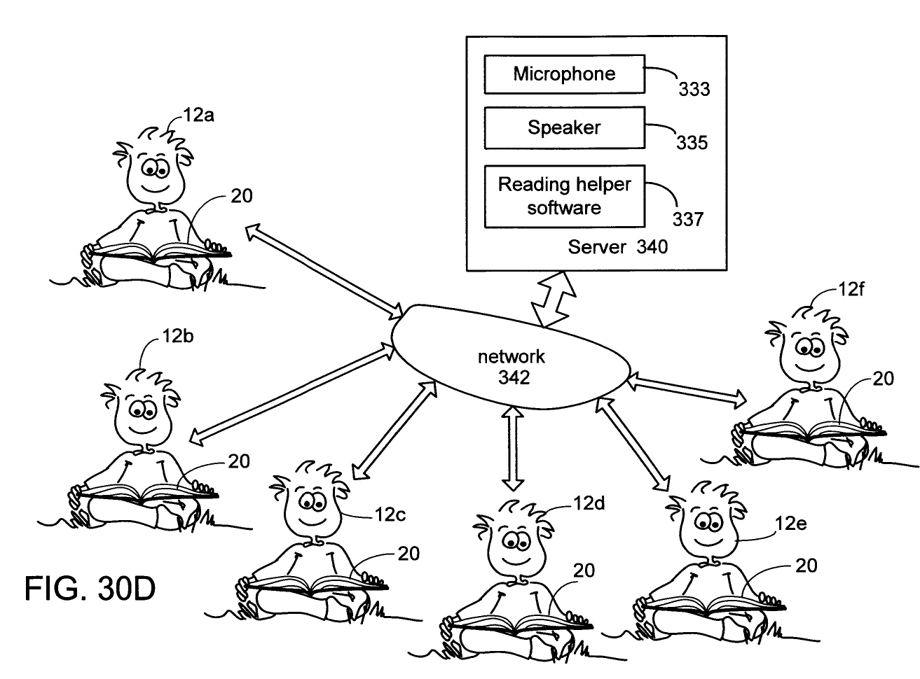

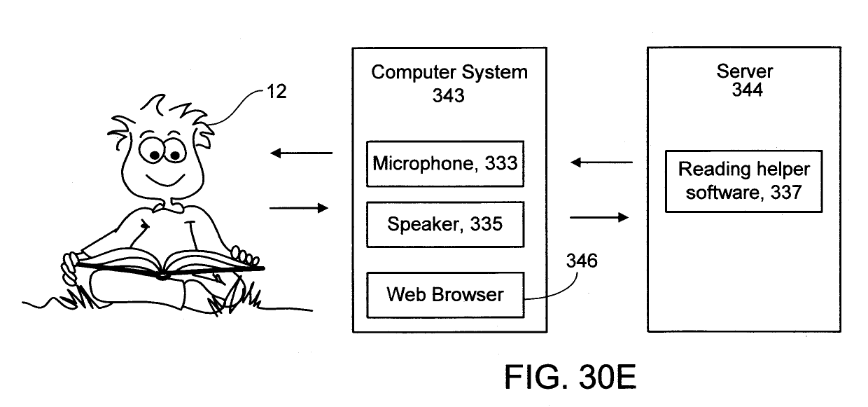

In some embodiments, as shown in FIG. 30A, the reading helper 30 can be implemented using a telephone system. In such embodiments, a user 12 can interact with the reading helper 322 over a telephone network. For example, the user 12 can wear a headset that includes earphones 320 and a microphone 322. The headset can be connected to a telephone 326 such that the user can have his/her hands free to focus on the book. Alternatively or additionally, the user 12 could hold a standard telephone handset or could use a speakerphone function on a telephone.

The user interacts with the reading helper 332 by speaking into the microphone 322. The user's voice is carried over a telephone line 328 to a computer system 330 that includes reading helper software 332. The computer system 330 can be located in remotely from the user 12. This enables the user to use the reading tutor system without requiring the user to possess a reading helper. The reading tutor software 332 can function as described above and provide audio feedback to the user 12 via the telephone line 328.

### Use of Computer System Instead of Stand Alone Device

While some embodiments described above the reading helper 30 is shown as a stand alone device, in some embodiments, as shown in FIG. 30B, the reading helper can be implemented using a computer 331. In such embodiments, a user 12 can interact with the computer 331 that includes the reading helper software 337. For example, the computer 331 can include a microphone 333 and a speaker 335 to receive audio input from the user and to provide audio feedback to the user, respectively. In some embodiments, the user 12 can wear a headset that includes earphones and a microphone. The headset can be connected to the computer 331 or can be wireless such that the user can have his/her hands free to focus on the book. In other embodiments, the microphone and speaker can be included in the computer 331. The user 12 interacts with the reading helper software 337 included on the computer 331 by speaking into the microphone 333. This enables the user to use the reading tutor system without requiring the user to possess a reading helper. The reading tutor software 337 can function as described herein and provide audio feedback to the user 12.

While some embodiments shown above the user reads from a physical text, in some embodiments, as shown in FIG. 30C, the reading helper can be implemented using a computer 331 and the text can be presented to the user on a display 339. In such embodiments, the user 12 can interact with the computer 331 that includes the reading helper software 337 by reading the text displayed on the display 339. The tutor reading helper software 337 includes passages that are displayed to a user on the display 339. The passages can include both text and related pictures. The computer 331 can include a microphone 333 and a speaker 335 to receive audio input from the user and to provide audio feedback to the user, respectively.

### Use of Computer System in Classroom or Multi-Device Setting

Referring now to FIG. 30D, a network arrangement of reading tutor systems is shown. This configuration is especially useful in a classroom environment where a teacher, for example, can monitor the progress of multiple users 12a, 12b, 12c, 12d, 12e, and 12f. The arrangement includes multiple ones users each possessing an individual copy of a text 20 coupled via a network 342, for example, a local area network, the Internet, a wide-area network, or an Intranet, to a server computer 340. The server computer 340 would include amongst other things a file stored, e.g., on a storage device, which holds the reading tutor software 337 and the electronic files 100 for one or more texts (e.g., as described in relation to FIG. 7). Each user can be coupled to the server 340 via a headset or other device that can send and receive electronic communications between the user and the server 340. For example, each user can have a headset that includes a microphone for receiving, utterances from the user and a speaker for providing audio instructions, commands, playback of text being read, music, sound effects, and/or other feedback to the user. The headset can be configured to transmit the utterances from the microphone to the server. The server can analyze the received utterances and transmit the feedback to the user via the speaker. Thus, in a classroom setting, multiple users can interact with the reading tutor software while individually reading his/her copy of a physical text.

### Use of Rending Helper Software via Web Browser

In some embodiments, as shown in FIG. 30E, the reading helper can be implemented using a computer 343 and a server 344 in such embodiments, a user 12 can interact with the computer 343. Computer 343 includes a web-browser 346 that is configured to receive input from the user and transmit the input to the server 344. The server 344 includes reading helper software 337. The user 12 interacts with the reading helper software 337 included on the server 344 via the web browser 346. For example, the computer 343 can include a microphone 333 and a speaker 335 to receive audio input from the user. The computer 343 transmits the audio to the server 344 which analyzes the audio input and provides audio feedback to the user 12 by sending the audio feedback to computer 343. This enables the user 12 to use the reading tutor system without requiring the user to possess the reading helper software 337. The reading helper software 337 can function as described herein and provide audio feedback to the user 12.

### Spelling Bee Feature

In some embodiments, the reading helper 30 includes a spelling feature. The spelling feature quizzes the user 12 on the spelling of words. For example, after completing a book the reading helper 30 could quiz the user 12 on the spelling of particular words in the story. In other examples, a user 12 could download a particular list of spelling words to be quizzed on or the words could be randomly selected.

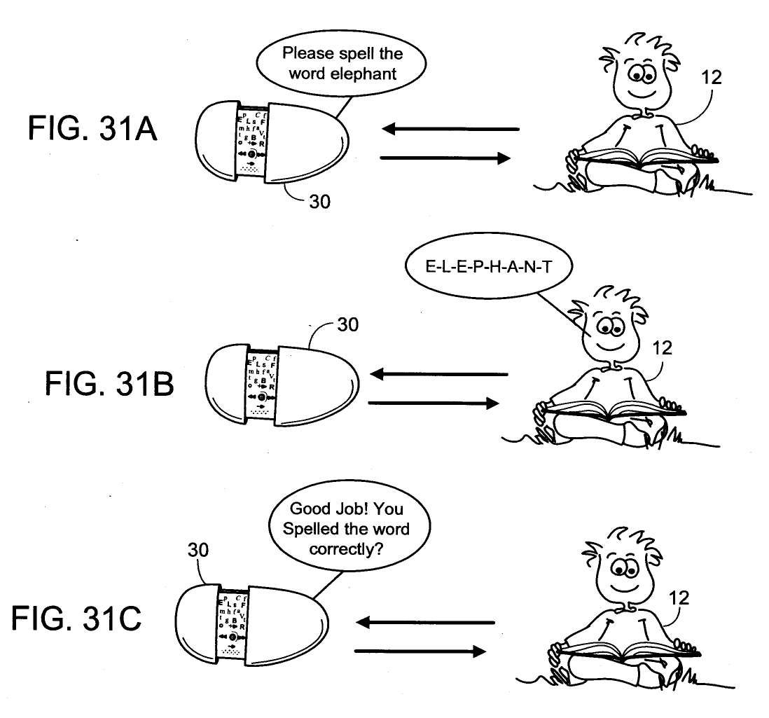

Referring to FIGS. 31A-31C, an exemplary use of the reading helper 30 in the spelling quiz mode is shown. As shown in FIG. 31A, the reading helper 30 requests for the user 12 to spell a particular word. In this example, the word is elephant. The user 12 begins spelling the word (FIG. 31B). The reading helper 30 listens to the user's spelling and determines if the user 12 correctly spells the word. If the user 12 spells the word correctly, the reading helper 30 indicates to the user 12 that he/she spelled the word correctly (FIG. 31C).

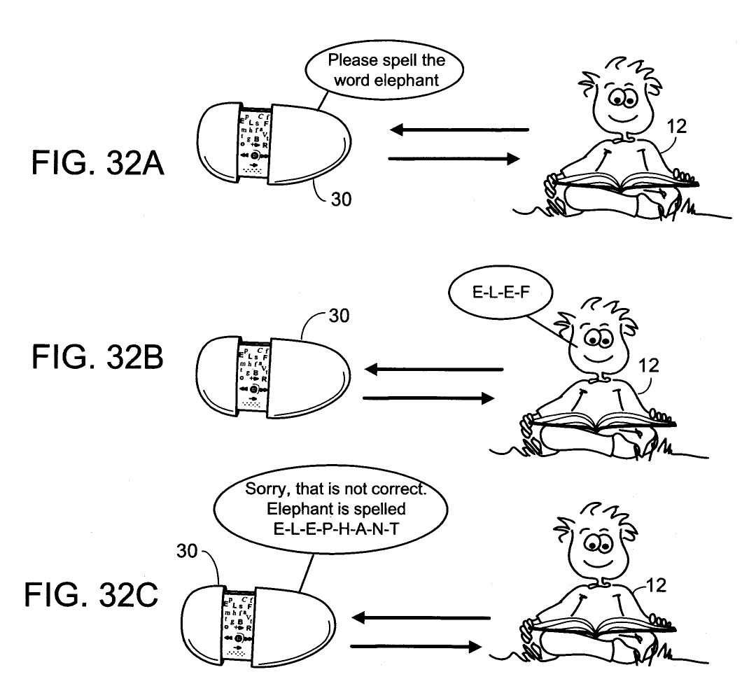

Referring to FIGS. 32A-32C, an exemplary use of the reading helper 30 in spelling mode when the user 12 does not spell the word correctly is shown. As shown in FIG. 32A, the reading helper 30 requests for the user 12 to spell a particular word. The user 12 then begins to spell the word, but spells the word incorrectly (FIG. 32B). The reading helper 30 listens to the user's spelling and determines that the user 12 has recited an incorrect letter, namely the user 12 has recited the letter ‘f’ rather than the letters ‘ph.’ In response, the reading helper 30 indicates that the user 12 has spelled the word incorrectly and recites the correct spelling for the word (FIG. 32C).

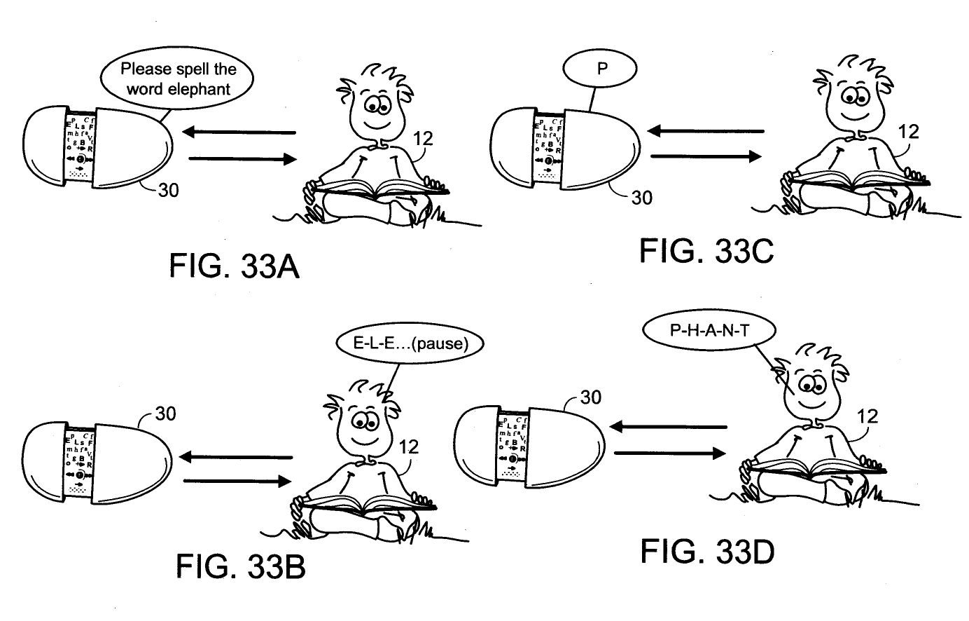

Referring to FIGS. 33A-33D, an exemplary use of the reading helper 30 in spelling mode is shown. As shown in FIG. 33.A, the reading helper 30 requests for the user 12 to spell a particular word. The user 12 begins to spell, the word, but then pauses (FIG. 33B). After a predetermined amount of time, the reading helper 30 determines that the user 12 might not know the next letter in the word and provides the next letter of the word to the user 12 (FIG. 33C). The user 12 can then proceed with, spelling the word (FIG. 33D).

### Line Learning Feature

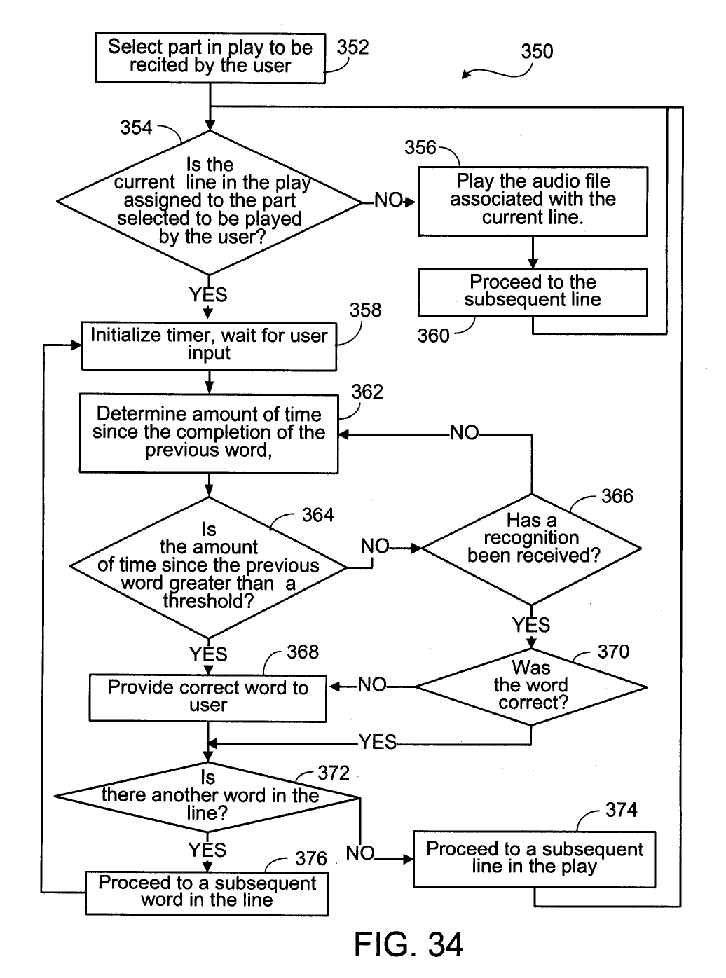

In some embodiments, the reading helper 30 can be used to help with memorization of a particular text or passage. Referring to FIG. 34, a process 350 for using the reading helper 30 to learn the lines of a play is shown. In order to interactively recite the lines of a play, the user 12 selects (352) the part for which he/she would like to recite the lines. The reading helper 30 determines (354), based on the selected part, if the current line of the play is a line that should be recited by the user 12. If the line is not a line that should be recited by the user 12, the reading helper 30 plays (356) an audio file associated with the current line and proceeds (360) to the next line in the play.

If the line is one that should be recited by the user 12, the reading helper 30 initializes 358 a timer and waits for input from the user 12. The reading helper 30 determines (362) the amount of time since the completion of the previous word (e.g., the time since the initialization of the timer) and determines (364) if the amount of time since the previous word is greater than a threshold. If the time is greater than the threshold, the user 12 has potentially forgotten or is struggling to remember the next word of his/her line. In order to help the user 12 with his/her line, the reading helper 30 provides (368) the correct word (or words) to the user. For example, the reading helper 30 can play an audio file with the next word (or words). The number of words provided to the user 12 can be set as desired, (e.g., one word, two words, three words, four words, five words, the rest of the line). After providing the correct word to the user, the reading helper 30 determines (372) if there is another word in the line that is to be recited by the user. If there is another word, the reading helper 30 proceeds (376) to the subsequent word and re-initializes (358) the timer. If there is not another word in the line, the reading helper 30 proceeds (374) to a subsequent line in the play and determines (354) if the line is to be recited by the user.

If the determined time is not greater than the threshold, the reading helper 30 determines (366) if a recognition has been received (e.g., if the user 12 has spoken a word). If a recognition has not been received, then the reading helper 30 re-determines (362) the amount of time since the previous word. If a recognition has been received, the reading helper 30 determines (370) if the received word was correct. If the word was not correct, then the reading helper 30 corrects the user 12 by providing (368) the correct word to the user. If the recognition was correct or after providing the correct word to the user, the reading helper 30 determines (372) if there is another word in the line that is to be recited by the user 12. If there is another word, the reading helper 30 proceeds (376) to the subsequent word and re-initializes (358) the timer. If there is not another word in the line the reading helper 30 proceeds (374) to a subsequent line in the play and determines (354) if the line is to be recited by the user 12.

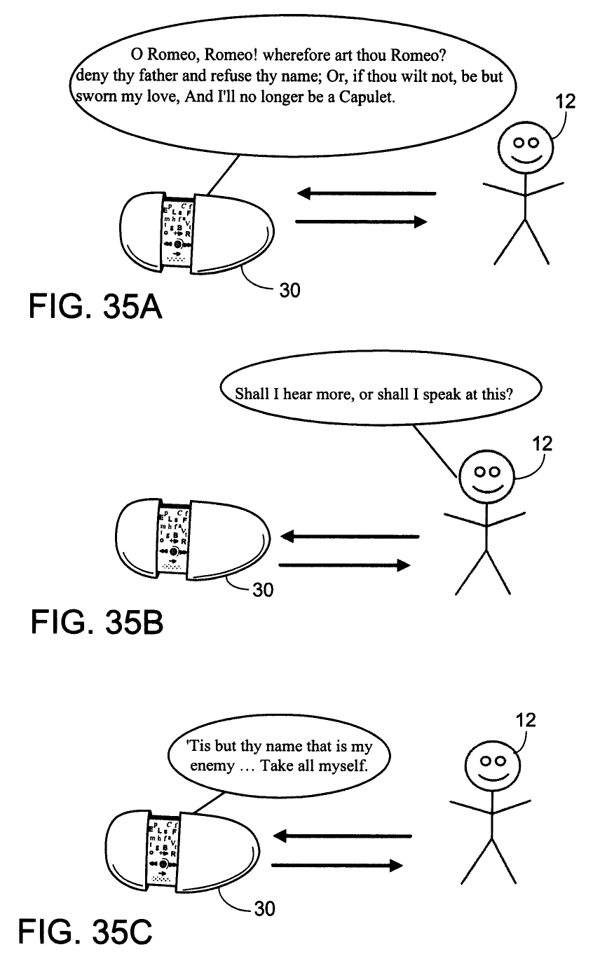

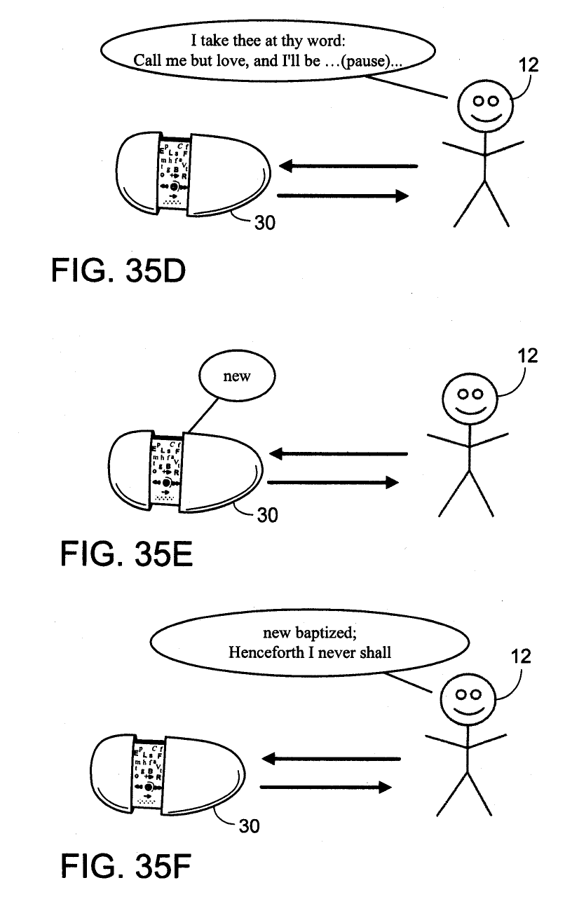

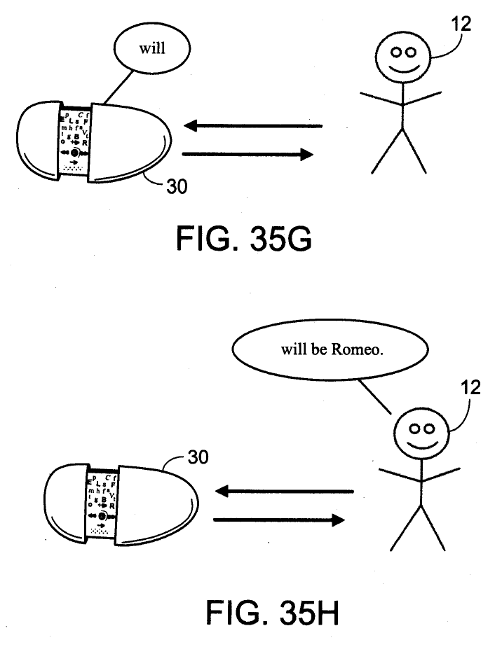

Referring to FIGS. 35A-35H, an exemplary use of the reading helper 30 to learn the lines in a play is shown. In the example shown in FIGS. 35A-35H, the user 12 is attempting to learn, the lines of Romeo in the Shakespeare play entitled “Romeo and Juliet.” The reading helper 30 speaks the lines of Juliet (and the other characters) while the user 12 recites the lines of Romeo. As shown in FIG. 35A, the reading helper 30 recites a line of the play. In response, the user 12 recites the next line of the play (FIG. 35B). After receiving the correct words from the user, the reading helper 30 plays the audio for the next line in the play (FIG. 35C). The user 12 then begins to recite the line, but forgets the words mid-way through the line and pauses (FIG. 35D). After the user 12 has paused for a predetermined length of time, the reading helper 30 provides the next word in the line to the user 12 (FIG. 35E). The user 12 then resumes saying the line, but says “henceforth I never shall” instead of the correct line “henceforth I never will” (FIG. 35F). When the reading helper 30 recognizes the incorrect word, namely “shall,” the reading helper 30 corrects the user 12 by saying the correct word, namely “will” (FIG. 35G). The user 12 then correctly completes the line (FIG. 35H).

### Math Drill Feature

In some embodiments, the reading helper 30 includes a math feature. The math feature quizzes the user 12 on various math skills. For example, the reading helper 30 can listen to a user 12 recite multiplication tables or can ask the user 12 math questions. The reading helper 30 listens to the user's responses and provides feedback regarding whether the result obtained by the user 12 is correct.

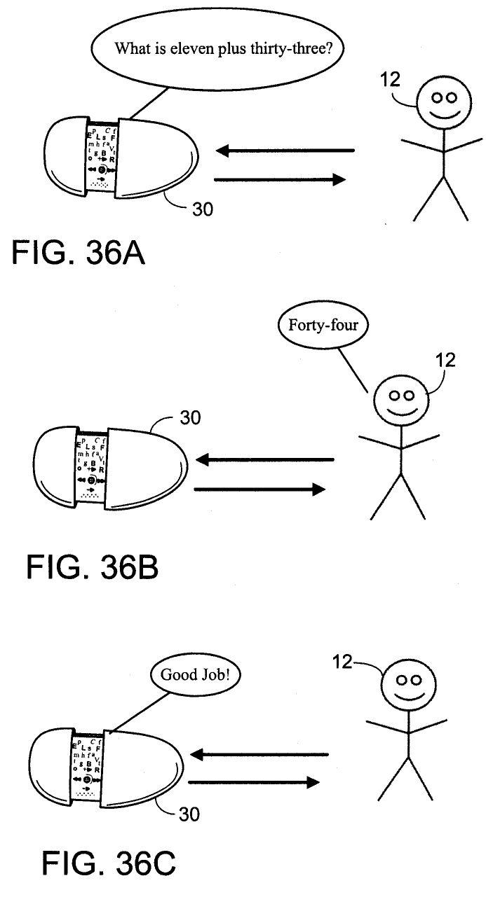

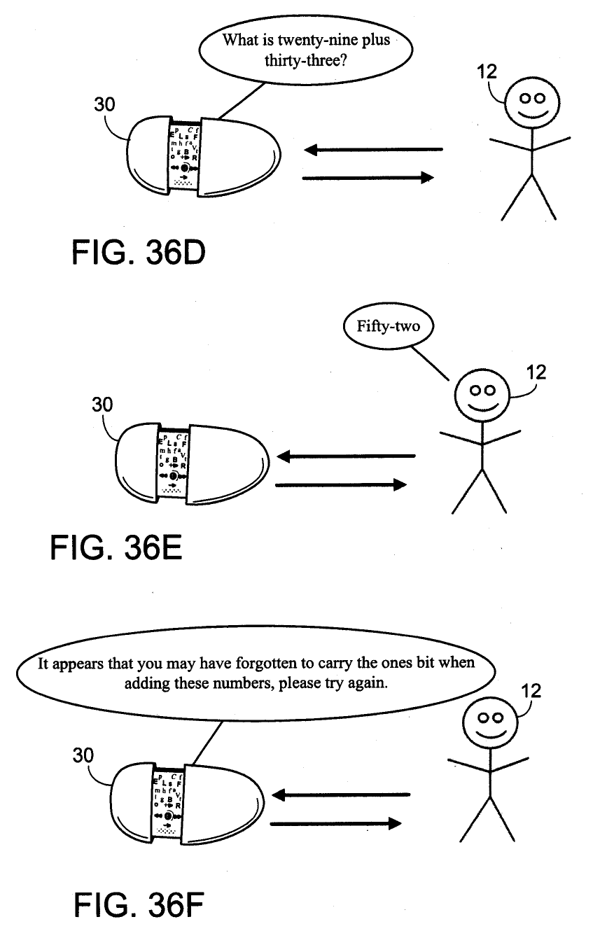

Referring to FIGS. 36A-36F, an exemplary use of the reading helper 30 in the math quiz mode is shown. As shown in FIG. 36A, the reading helper 30 requests for the user 12 perform a particular calculation and recite the result. In this example, the question is the addition of eleven plus thirty-three. The user 12 performs the addition and states the result (FIG. 36B). The reading helper 30 listens to the user's response and determines if the user 12 correctly performed the addition. If the user 12 provides the correct answer, the reading helper 30 indicates to the user 12 that he/she is correct (FIG. 36C). The reading helper 30 can then provide another question. As shown in FIG. 36G, the reading helper 30 requests for the user 12 add twenty-nine plus thirty-three. In this example the user 12 provides the answer of fifty-two which is incorrect. In response, the reading helper 30 informs the user 12 that the answer was incorrect. For some answers, such as the answer in this example, the answer provided by the user 12 is an answer that results from a common error. Here the error is that the user 12 has forgotten to carry the one to the tens position of the number. Thus, the user 12 provided an answer of fifty-two rather than sixty-two. For such common mistakes, the reading helper can store responses that indicate the type of mistake to the user. For example, as shown in FIG. 36F, the reading helper 30 provides feedback to the user 12 indicating that the user 12 may have forgotten to carry the ones bit.

While in the examples shown in FIGS. 36A-F, the reading helper 30 provided questions on addition, other math questions such as subtraction, multiplication, division, recitation of series, and the like could be used by the reading helper 30. In some additional embodiments, the reading helper can provide the math problems in the form of a word problem. The reading helper 30 can then interact with the user to help foe user to determine the relevant information from the word problem and to determine if the user 12 correctly solved the word problem.

### Interactive Learning Functionality

While the embodiments above have described particular examples of interactive uses of the reading helper 30 such as learning the lines of a play, spelling practice, and math practice other functionality could be included. For example, the reading helper 30 could quiz a user 12 on geography using a map with numbers or colors used by the user 12 to identify that he/she has correctly located a particular state, country, or continent. The reading helper 30 could also quiz the user 12 on any type of questions for which a limited set of responses is expected. For example, the reading helper 30 could quiz the user 12 by providing multiple choice questions, true/false questions, fill in the blank questions, and/or open-ended questions for which a limited number of answers are expected. For example, the reading helper 30 could quiz the user 12 on state capitals, reading-comprehension, the presidents, trivia, map reading, memorization of a passage such as the pledge of allegiance, the constitution, poetry or other passages. In general, the reading tutor 30 can be used to enhance comprehension of any desired subject for which suitable questions can be formulated.

### Reading Testing

In some embodiments, the reading helper 30 can include a reading test mode. In the reading test mode, the reading helper can listen to the user 12 read a complete text without providing any interruptions or feedback. After the user 12 has completed reading the text, the reading helper 30 could provide a score or other feedback to the user. For example, the reading helper 30 could count the number of incorrect words and provide a score based on the number of incorrect words.

### Authoring Tool

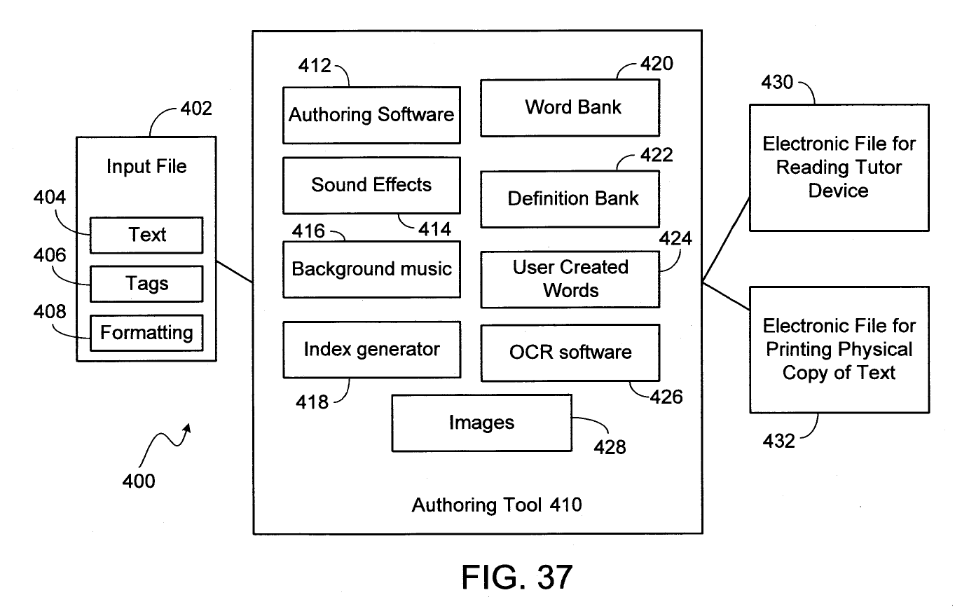

As described above, the reading helper 30 uses an electronic file 100 with foreknowledge of a particular book, story, or other text to interact with a user 12 who is reading the text. The electronic file 430 can be generated using an authoring environment 400 as shown in FIG. 37. The authoring environment includes an authoring tool 410. The authoring tool 410 receives an input file 402 that includes the text 404 of the content for which the electronic file 430 is to be generated. In addition, the input file 402 may include tags 406 or formatting 408 to aid in the generation of the electronic file 430. For example, the tags 406 and formatting 408 could be used to integrate music, graphics, sound effects, or other information about the content into the electronic file.

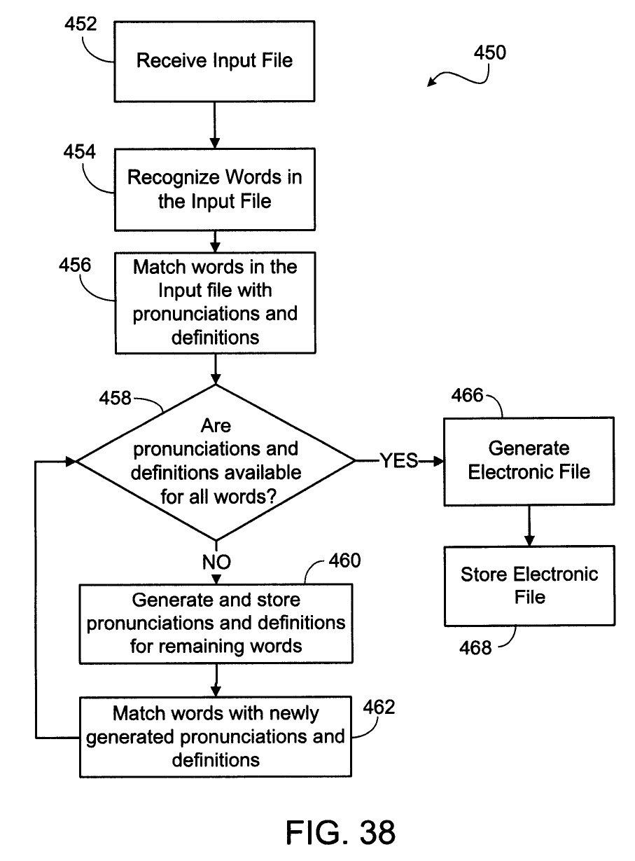

The authoring tool 410 includes authoring software 412, sound effects 414, background music 416, an index generator 418, a word bank 420, a definition bank 422, user created words 424, images 428, and optical character recognition software 426. As shown in FIG. 38, the authoring tool 410 receives (452) the input file 402 and recognizes (454) the words in the input file. For example, the authoring tool 410 can receive the input file in an editable form such as a text file, word document, or other electronically readable file. The input file could additionally or alternatively be received in a non-editable format such as a pdf file, fax, or handwritten text. If the input file is received in such a non-editable format, the authoring tool 410 converts the received input file 402 into a machine modifiable file using, for example, optical character recognition 428. The authoring tool 410 matches (456) the words in the input file 402 with the word pronunciations stored in the word bank 420 and with the definitions stored in the definition bank 422. The word bank 420 and definition bank 422 may not include every word present in the received input file 402. For example, the word bank 420 and definition bank 422 might not include the proper names of characters in the input file 402. In order to provide a proper pronunciation and definition for the words not included in the word bank 420 and definition bank 422, the authoring tool 410 determines (458) if pronunciations and definitions are available for all words in the input file 402. If pronunciations and definitions are not available for some words, the authoring tool 410 generates and stores (460) pronunciations and definitions for those words. For example, the authoring tool can request for the user to provide a pronunciation. Alternatively, the authoring tool 410 can generate a pronunciation based on phonetics. The generated words can be stored in a user created words file 424 that is associated with the input file. Based on the newly generated pronunciations and definitions, the authoring tool matches (462) the previously unmatched words to the newly generated pronunciations and definitions and re-determines (458) if all of the words have been matched with pronunciations and definitions.

If the authoring tool determines (458) that pronunciations and definitions were available for all words in the input file 402 either based on the words and definitions initially stored in the word bank 420 and definition bank 422 or using the user created words 424, the authoring tool generates (466) and stores (468) the electronic file associated with the input.

In some embodiments, the user may desire to add functionality to the electronic file in addition to the word pronunciations and definitions. In order to add additional functionality, the user can provide an input file 402 that includes tags 406 or formatting 408 to indicate music or sound effects to be included in the electronic file. Alternatively, the authoring tool 410 can include a user interface that allows the user to select sound effects and music and to associate the sound effects and music to a portion of the text or to the entire text.

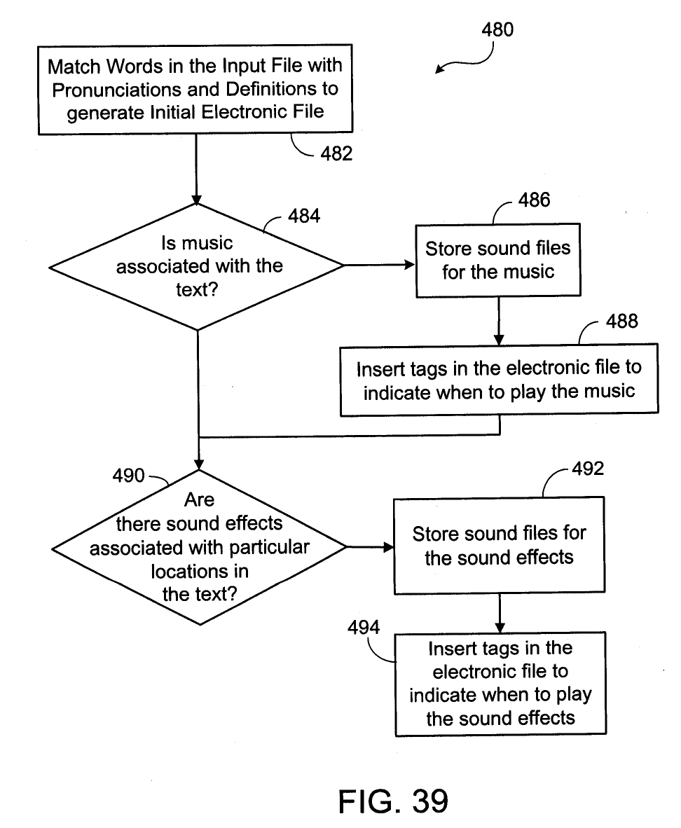

As shown in FIG. 39, the authoring tool 410 matches (482) the words in the input file with pronunciations and definitions to generate an electronic file with foreknowledge of the text as described above. The authoring fool determines (484) if there is music to link with the text. For example, the authoring tool could be interactive and request a response from the user regarding whether or not they desire to add music. Alternatively or additionally such information could be included in the input file. If there is music to associate with the text, the authoring tool receives and stores (486) the sound files for the music in the background music file 416. In some embodiments, music files could be pre-stored in the music file 416. In order to associate the music with particular portions of the text, the authoring tool inserts (488) tags in the electronic file to indicate when particular music files should be played.

The authoring tool also determines (490) if there are sound effects to associate with the text. If there are sound effects, the authoring tool receives and stores (492) the sound files for the sound effects in the sound effects file 414. In some embodiments, sound effects could be pre-stored in the sound effects file 414. In order to associate the sound effects with particular portions of the text or locations within the text, the authoring tool inserts (494) tags in the electronic file to indicate when particular sound effect files should be played. For example, if the text included the sentence “the door to the haunted house opened slowly” and the user desired to associate a sound effect of a creaky door with this portion of the text, a tag could be inserted linking the creaky door sound effect with the final word in the sentence. By inserting a tag to play the sound effect with the final word in the sentence, when the user of the reading helper 30 reads the word slowly, the sound effect of the creaky door would be played.

Other implementations are within the scope of the claims.

What is claimed is:

1. A method for assisting in learning, the method comprising:
receiving an audio file that includes a response from a user;
generating a comparison result by comparing the response to one or more stored responses using speech recognition;
determining based on the comparison result if the user has provided a correct response; and
providing audio feedback to the user based on the comparison result, the audio feedback comprising feedback to assist in the user's learning.

2. The method of claim 1, further comprising requesting a response from the user.

3. The method of claim 1, wherein the one or more stored responses includes at least one correct response and at least one incorrect response, the incorrect response being associated with an identifiable type of error.

4. The method of claim 3, wherein providing audio feedback to the user based on the comparison result comprises:
playing a first audio file indicating a correct response if the comparison result indicates that a match exists between the received audio and the correct response,
playing a second audio file indicating the type of error if the comparison result indicates that a match exists between the received audio and the incorrect response, and
playing a third audio file if the comparison result indicates that a match does not exist between the received audio and the correct response or the incorrect response, the first audio file, second audio file, and third audio file being different.

5. The method of claim 1, wherein
requesting the response from the user comprises asking the user to spell a particular word;
receiving an audio file comprises receiving an audio file that includes a plurality of letters;
generating a comparison result comprises determining if the plurality of letters in the audio file corresponds to the letters of the particular word; and
providing audio feedback to the user comprises indicating if the word was spelled correctly.

6. The method of claim 1, wherein
requesting the response from the user comprises asking the user to perform a particular mathematical calculation;
receiving an audio file comprises receiving an audio file that includes a numeric response;
generating a comparison result comprises determining if the numeric response in the audio file corresponds to the result of the calculation; and
providing audio feedback to the user comprises indicating if the mathematical calculation was performed correctly.

7. The method of claim 1, wherein
requesting the response from the user comprises reciting the lines of one or more characters in a play, but not the lines of a particular character;
receiving an audio file comprises receiving an audio file that includes a line of the particular character;
generating a comparison result comprises determining if the received audio rile corresponds to the correct words in the line of the particular character; and
providing audio feedback to the user comprises providing a next word to a user if the received audio file does not correspond to the correct words in the line.

8. A method comprising:
using a device having foreknowledge of expected responses to provide interactive feedback to a user of the device, the interactive feedback comprising feedback to assist the user in learning a particular set of information.

9. The method of claim 8, wherein the particular set of information comprises mathematical skills.

10. The method of claim 8, wherein the particular set of information comprises spelling skills.

11. The method of claim 8, wherein the particular set of information comprises comprehension skills.

12. The method of claim 8, wherein the particular set of information comprises memorization skills.

13. A computer program product, tangibly embodied in an information carrier, for executing instructions on a processor, the computer program product being operable to cause a machine to:
receive an audio file that includes a response from a user;
generate a comparison result by comparing the response to one or more stored responses using speech recognition;
determine based on the comparison result if the user has provided a correct response; and
provide audio feedback to the user based on the comparison result, the audio feedback comprising feedback to assist in the user's learning.

14. The computer program product of claim 13, further comprising instructions to cause a machine to request a response from the user.

15. A computer program product, tangibly embodied in an information carrier, for executing instructions on a processor, the computer program product being operable to cause a machine to:
use a device having foreknowledge of expected responses to provide interactive feedback to a user of the device, the interactive feedback comprising feedback to assist the user in learning a particular set of information.

16. The computer program product of claim 15, wherein the particular set of information comprises a set of information selected from the group consisting of mathematical skills, spelling skills, comprehension skills, and memorization skills.

17. A system comprising:
a memory having one or more stored responses stored thereon; and
a processor configured to:
receive an audio file that includes a response from a user;
generate a comparison result by comparing the response to the one or more stored responses using speech recognition;
determine based on the comparison result if the user has provided a correct response; and
provide audio feedback to the user based on the comparison result, the audio feedback comprising feedback to assist in the user's learning.

18. The system of claim 17, wherein the processor is further configured to request a response from the user.

19. A system comprising:
a memory having foreknowledge of expected responses stored thereon; and
a processor configured to:
use the foreknowledge of expected responses stored in the memory to provide interactive feedback to a user, the interactive feedback comprising feedback to assist the user in learning a particular set of information.

20. The system of claim 19, wherein the particular set of information comprises a set of information selected from the group consisting of mathematical skills, spelling skills, comprehension skills, and memorization skills.
